(19) United States
(12) Patent Application Publication
(10) Pub. No.: US 2025/0239969 A1
(43) Pub. Date: Jul. 24, 2025

(54) ACTIVE COMPONENT INDICATORS FOR PHOTOVOLTAIC SYSTEMS

(71) Applicant: GAF Energy LLC, Parsippany, NJ (US)

(72) Inventors: Richard Perkins, San Jose, CA (US); Babak Farhangi, Kew Gardens Hills, NY (US)

(21) Appl. No.: 19/034,187

(22) Filed: Jan. 22, 2025

Related U.S. Application Data
(63) Continuation of application No. 18/325,381, filed on May 30, 2023, now Pat. No. 12,237,809.
(60) Provisional application No. 63/349,389, filed on Jun. 6, 2022.

(51) Int. Cl. H02S 50/10; H02S 20/23; H02S 40/34; H02S 40/36

(52) U.S. Cl. CPC H02S 50/10; H02S 20/23; H02S 40/34; H02S 40/36

(57) ABSTRACT

A system includes a plurality of photovoltaic modules installed and arranged in an array on a roof deck. Each of the photovoltaic modules includes a wire cover bracket configured to receive at least one electrical component. A rapid shutdown device is electrically connected to the at least one electrical component. The rapid shutdown device is configured to reduce an electrical voltage of the system to a predetermined voltage level. At least one visible indicator is electrically connected to the plurality of photovoltaic modules. The at least one visible indicator is activated when the electrical voltage of the system is less than or equal to the predetermined voltage level.

### CROSS-REFERENCE TO RELATED APPLICATION

This application is a continuation of U.S. patent application Ser. No. 18/325,381, filed May 30, 2023, entitled “ACTIVE COMPONENT INDICATORS FOR PHOTOVOLTAIC SYSTEMS,” which claims the benefit of commonly-owned, co-pending U.S. Provisional Patent Application Ser. No. 63/349,389, filed Jun. 6, 2022, entitled “ACTIVE COMPONENT INDICATORS FOR PHOTOVOLTAIC SYSTEMS,” the contents of each of which are incorporated herein by reference in their entirety.

### FIELD OF THE INVENTION

The present invention relates to active component indicators for photovoltaic systems.

### BACKGROUND OF THE INVENTION

Photovoltaic systems having solar panels and other active components are commonly installed on roofing of structures.

### SUMMARY OF THE INVENTION

In some embodiments, a system includes a plurality of photovoltaic modules installed on a roof deck, wherein the photovoltaic modules are arranged in an array on the roof deck, wherein the array includes a first subarray, wherein each of the photovoltaic modules includes a first end and a second end opposite the first end, at least one solar cell, and a wire cover bracket located at the first end, wherein the wire cover bracket is configured to receive at least one electrical component, wherein the wire cover brackets of the plurality of photovoltaic modules of the first subarray are configured to form a wireway; a rapid shutdown device, wherein the rapid shutdown device is electrically connected to the at least one electrical component, wherein the rapid shutdown device is configured to reduce an electrical voltage of the system to a predetermined voltage level; and at least one visible indicator, wherein the at least one visible indicator is electrically connected to the plurality of photovoltaic modules, wherein the at least one visible indicator is activated when the electrical voltage of the system is less than or equal to the predetermined voltage level.

In some embodiments, the at least one visible indicator is a light source. In some embodiments, the light source is a light emitting diode (LED). In some embodiments, the system further includes a transition box, wherein the transition box is located proximate to the wireway, wherein the rapid shutdown device is located within the transition box, wherein the at least one visible indicator is located within the transition box. In some embodiments, the at least one visible indicator is located within the wireway. In some embodiments, the at least one visible indicator is located within a corresponding one of the wire cover bracket. In some embodiments, the at least one visible indicator includes a plurality of visible indicators.

In some embodiments, the system further includes at least one cover removably attached to at least one of the wire cover brackets, wherein the at least one cover is configured to enable visible perception of the at least one visible indicator when the at least one visible indicator is active. In some embodiments, the system further includes at least one voltage monitoring device, wherein the at least one voltage monitoring device is configured to measure the electrical voltage. In some embodiments, the system further includes a jumper module, wherein the jumper module electrically connects the first subarray of the array and a second subarray of the array. In some embodiments, the jumper module includes a first junction box, wherein the at least one electrical component includes a second junction box, wherein the first junction box is electrically connected to the second junction box, and wherein the first junction box includes the at least one voltage monitoring device. In some embodiments, the jumper module includes a plurality of layers, wherein the plurality of layers is laminated, and wherein the at least one voltage monitoring device is laminated within plurality of layers of the jumper module. In some embodiments, the at least one voltage monitoring device is a printed circuit board or flex circuit.

In some embodiments, the at least one visible indicator is located on the jumper module. In some embodiments, the at least one voltage monitoring device includes a plurality of voltage monitoring devices, and wherein each of the plurality of voltage monitoring devices is located on a corresponding one of the plurality of photovoltaic modules. In some embodiments, the at least one visible indicator is electrically connected to the rapid shutdown device. In some embodiments, the predetermined voltage level is 0.1 volt to 30 volts.

In some embodiments, the at least one visible indicator displays a first color when the electrical voltage has a first value, and wherein the at least one visible indicator displays a second color different from the first color when the electrical voltage has a second value, wherein the second value is different from the first value. In some embodiments, the at least one visible indicator displays a first flashing code when the electrical voltage has a first value, and wherein the at least one visible indicator displays a second flashing code different from the first flashing code when the electrical voltage has a second value, wherein the second value is different from the first value.

In some embodiments, a method comprises the steps of: monitoring an electrical voltage of a photovoltaic system, wherein the photovoltaic system includes a plurality of photovoltaic modules installed on a roof deck, wherein the photovoltaic modules are arranged in an array on the roof deck, wherein each of the photovoltaic modules includes a first end and a second end opposite the first end, at least one solar cell, and at least one electrical component, a rapid shutdown device, wherein the rapid shutdown device is electrically connected to the at least one electrical component, and at least one visible indicator, wherein the at least one visible indicator is electrically connected to the plurality of photovoltaic modules; activating the rapid shutdown device to reduce the electrical voltage of the photovoltaic system to a predetermined voltage level; and activating the at least one visible indicator when the electrical voltage of the photovoltaic system is less than or equal to the predetermined voltage level.

### BRIEF DESCRIPTION OF THE DRAWINGS

FIGS. 1A and 1B are top plan views of some embodiments of a photovoltaic module;

FIGS. 2 and 3 are schematic view of some embodiments of a photovoltaic module;

FIG. 4 is a top perspective view of some embodiments of a jumper module for a photovoltaic system;

FIG. 5 is a top plan view of the jumper module shown in FIG. 4;

FIG. 6 is a side elevational view of the jumper module shown in FIG. 4;

FIG. 7 is a bottom plan view of the jumper module shown in FIG. 4;

FIG. 8 is an exploded, top perspective view of an active portion of the jumper module shown in FIG. 4;

FIG. 9 is schematic view of the active portion of the jumper module shown in FIG. 4;

FIG. 10 is a top plan view of a jumper module shown in FIG. 4 overlaying another one of the jumper module;

FIG. 11 is an exploded, top perspective view of a photovoltaic system;

FIGS. 12A and 12B are views of embodiments of photovoltaic modules and associated wire cover brackets;

FIG. 13 is a top perspective view of embodiments of a cover installed on wire cover brackets;

FIG. 14 is a top perspective view of embodiments of a first flashing base employed by the photovoltaic system shown in FIG. 11;

FIG. 15 is a top perspective view of embodiments of flashing bases installed on a roof deck;

FIGS. 16A through 17 are top perspective views of a transition box employed by the photovoltaic system shown in FIG. 11;

FIG. 18 is a top perspective view of embodiments of the transition box shown in FIGS. 16A through 17 installed on a roof deck;

FIGS. 18A through 18D illustrate some embodiments of a transition box;

FIG. 19 is a top perspective view of embodiments of a second flashing base employed by the photovoltaic system shown in FIG. 11;

FIGS. 20 and 20A are top perspective views of embodiments of a building integrated photovoltaic system installed on a roof deck; and

FIGS. 21 and 22 illustrate block-diagrams of some embodiments of indicators employed by a photovoltaic system.

### DETAILED DESCRIPTION

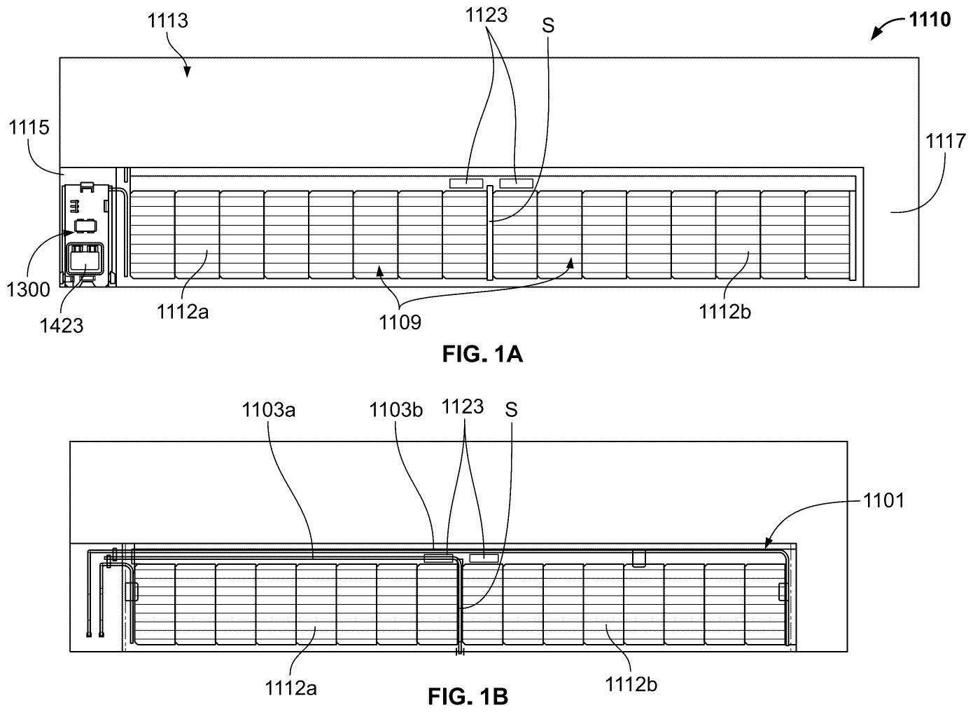

Referring to FIGS. 1A and 1B, in some embodiments, a photovoltaic module 1110 includes an active area 1109 having a plurality of solar cells 1112. In some embodiments, the photovoltaic module 1110 includes an inactive area comprising a head lap portion 1113, a first side lap 1115 located at one end of the photovoltaic module 1110, and a second side lap 1117 located at an opposite end of the photovoltaic module 1110. In some embodiments, the head lap portion 1113 is textured. In some embodiments, the texture of the head lap portion 1113 is different from a texture of the active area 1109. In some embodiments, a wire cover bracket 1300 is attached to the first side lap 1115. In some embodiments, the wire cover bracket 1300 includes a junction box 1423.

In some embodiments, the plurality of solar cells 1112 includes a first set of solar cells 1112a and a second set of solar cells 1112b. In some embodiments, the first set of solar cells 1112a includes eight of the solar cells 1112. In some embodiments, the second set of solar cells 1112b includes eight of the solar cells 1112. In some embodiments, each of the first set of solar cells 1112a and the second set of solar cells 1112b includes more or less than eight of the solar cells 1112. In some embodiments, a last one of the solar cells 1112 of the first set of solar cells 1112a is separated from a first one of the solar cells 1112 of the second set of solar cells 1112b by a space S. In some embodiments, the space S is located approximately half the length of the photovoltaic module 1110. In some embodiments, the solar cells 1112 of each of the first and second sets of solar cells 1112a, 1112b are strung together with bussing 1101. In some embodiments, the bussing 1101 includes nine bussing wires. In some embodiments, the bussing 1101 may include more or less than the nine bussing wires.

In some embodiments, a first bussing wire 1103a extends from the first side lap 1115 to the space S. In some embodiments, the first bussing wire 1103a extends to approximately half the length of the photovoltaic module 1110. In some embodiments, one end of the first bussing wire 1103a is electrically connected to the junction box 1423 and the other end of the first bussing wire 1103a is electrically connected to the first set of solar cells 1112a. In some embodiments, a second bussing wire 1103b extends from the first side lap 1115 to a location proximate to the second side lap 1117. In some embodiments, the second bussing wire 1103b extends substantially the entire length of the photovoltaic module 1110. In some embodiments, one end of the second bussing wire 1103b is electrically connected to the junction box 1423 and the other end of the second bussing wire 1103b is electrically connected to the second set of solar cells 1112b. In some embodiments, each of the first bussing wire 1103a and the second bussing wire 1103b is covered with a polymer layer. In some embodiments, each of the first bussing wire 1103a and the second bussing wire 1103b is covered with an insulating film. In some embodiments, the insulating film is composed of EPE. In some embodiments, the EPE is comprised of a black strip. In some embodiments, each of the first bussing wire 1103a and the second bussing wire 1103b is coated with a colorant or dye to reduce reflectivity.

In some embodiments, the photovoltaic module 1110 includes at least one bypass diode 1123. In some embodiments, the at least one bypass diode 1123 is electrically connected to the bussing 1101. In some embodiments, the at least one bypass diode 1123 includes a plurality of bypass diodes 1123. In some embodiments, the at least one bypass diode 1123 is located within a section of the photovoltaic module 1110 that is located between an upper edge of the photovoltaic module 1110 and the plurality of solar cells 1112.

In some embodiments, the plurality of solar cells 1112 includes a plurality of the solar cells 1112. In some embodiments, the plurality of solar cells 1112 is arranged in one row (i.e., one reveal). In some embodiments, the plurality of solar cells 1112 is arranged in two rows (i.e., two reveals). In some embodiments, the plurality of solar cells 1112 is arranged in three rows (i.e., three reveals). In some embodiments, the plurality of solar cells 1112 is arranged in four rows (i.e., four reveals). In some embodiments, the plurality of solar cells 1112 is arranged in five rows (i.e., five reveals). In some embodiments, the plurality of solar cells 1112 is arranged in six rows (i.e., six reveals). In some embodiments, the plurality of solar cells 1112 is arranged in more than six rows.

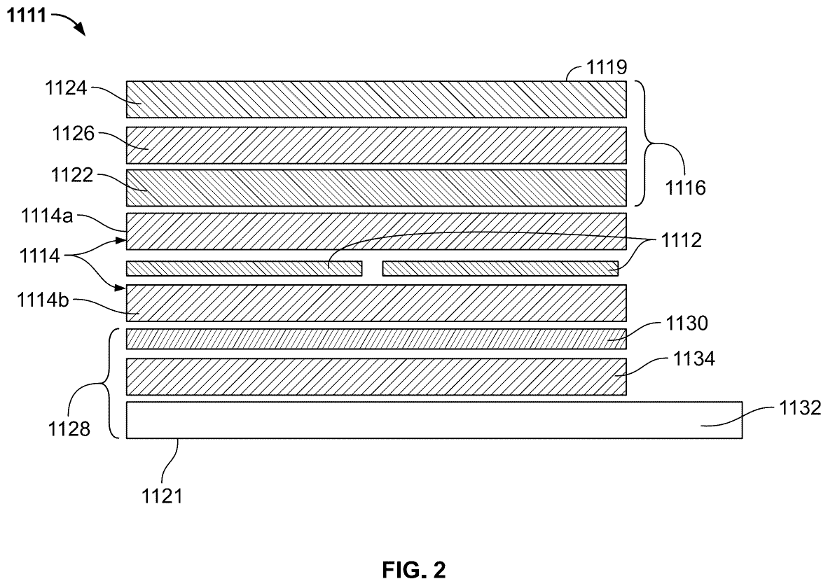

Referring to FIG. 2, in some embodiments, the active area 1109 of the photovoltaic module 1110 includes the plurality of solar cells 1112, an encapsulant 1114 encapsulating the plurality of solar cells 1112, and a frontsheet 1116 juxtaposed with the encapsulant 1114. In some embodiments, the frontsheet 1116 is juxtaposed with a first surface of the encapsulant 1114. As used herein, the terms “encapsulating” and “encapsulates” mean to partially or fully envelope or enclose, and with respect to certain embodiments of the photovoltaic module 1110, the plurality of solar cells 1112 is fully enveloped by or enclosed within the encapsulant 1114, or partially enveloped by or enclosed within the encapsulant 1114. In some embodiments, the plurality of solar cells 1112 includes a plurality of the solar cells 1112. In some embodiments, the encapsulant 1114 encapsulates 50% to 99.9% of an exterior surface area of the plurality of solar cells 1112.

In some embodiments, the encapsulant 1114 has a thickness of 0.5 mm to 4 mm. In some embodiments, the encapsulant 1114 includes a first layer 1114a and a second layer 1114b. In some embodiments, the first layer 1114a of the encapsulant 1114 initially comprises two layers prior to lamination thereof. In some embodiments, a first layer 1114a of the encapsulant 1114 has a thickness of 0.2 mm to 2 mm. In some embodiments, a second layer 1114b of the encapsulant 1114 has a thickness of 0.2 mm to 2 mm. In some embodiments, the thickness of the first layer 1114a is equal to the thickness of the second layer 1114b. In some embodiments, the thickness of the first layer 1114a is different from the thickness of the second layer 1114b. In some embodiments, the first layer 1114a of the encapsulant 1114 has a thickness that is sufficient to prevent or reduce leakage current to an amount that will not provide a risk of electrocution to a user by touch in the event the glass layer 1122 breaks or shatters. In some embodiments, such thickness of the first layer 1114a of the encapsulant 1114 is described above. In some embodiments, the first layer 1114a of the encapsulant 1114 has a thickness that is sufficient to prevent or reduce leakage current to an amount that will not provide a risk of electrocution to a user by touch when the photovoltaic module 1110 is wet, in the event the glass layer 1122 breaks or shatters. In some embodiments, such thickness of the first layer 1114a of the encapsulant 1114 is described above.

In some embodiments, the photovoltaic module 1110 withstands walking loads/step resistance that conforms to standards under UL 3741 test standards (UL Standard for Safety Photovoltaic Hazard Control). In some embodiments, the photovoltaic module 1110 includes an axe impact resistance that conforms to standards under UL 3741 test standards. In some embodiments, the photovoltaic module 1110 includes a body fall resistance that conforms to standards under UL 3741 test standards. In some embodiments, a wet leakage current test performed in accordance with UL 3741 results in a leakage current of less than 130 nA.

In some embodiments, the photovoltaic module 1110 includes an impact resistance that conforms to standards under UL 1703 test standards. The UL 1703 test involves attaching the photovoltaic module 1110 to a representative model of a roof and dropping a 2-inch diameter steel ball onto the photovoltaic module 1110 from 1.3 meters. A photovoltaic module is deemed to pass the UL 1703 standard if there are no exposed electrical components and no large pieces of glass are ejected.

In some embodiments, the encapsulant 1114 may be composed of polyolefins, ethyl vinyl acetates, ionomers, silicones, poly vinyl butyral, epoxies, polyurethanes, or combinations/hybrids thereof. In some embodiments, the encapsulant 1114 is composed of thermosetting polyolefin. In some embodiments, the photovoltaic module 1110 includes a first surface 1119 and a second surface 1121 opposite the first surface 1119. In some embodiments, the first surface 1119 is an upper, sun facing-side surface of the photovoltaic module 1110, and the second surface 1121 is a lower surface configured to face a roof deck on which the photovoltaic module 1110 is installed.

In some embodiments, the frontsheet 1116 includes a glass layer 1122 and a polymer layer 1124 attached to a first surface of the glass layer 1122. In some embodiments, the frontsheet 1116 is juxtaposed with the first layer 1114a of the encapsulant 1114. In some embodiments, each of the encapsulant 1114, the glass layer 1122, and the polymer layer 1124 is transparent. In some embodiments, the polymer layer 1124 is attached to the glass layer 1122 by a first adhesive layer 1126. In some embodiments, the first adhesive layer 1126 may include polyvinyl butyrate, acrylic, silicone, or polycarbonate. In some embodiments, the first adhesive layer 1126 may include pressure sensitive adhesives. In some embodiments, the polymer layer 1124 is attached to the glass layer 1122 by thermal bonding. In some embodiments, the frontsheet 1116 includes at least one of the glass layer 1122 or the polymer layer 1124. In some embodiments, the first adhesive layer 1126 is transparent. As used herein, the term “transparent” means having a solar weighted transmittance of 80% or greater, and with respect to certain embodiments of the photovoltaic module 1110, a transparent layer of the photovoltaic module has a solar weighted transmittance of 80% or greater. In some embodiments, the frontsheet 1116 does not include the glass layer 1122. In some embodiments, the polymer layer 1124 is textured. In some embodiments, the glass layer 1122 has a thickness of 1 mm to 6 mm.

In some embodiments, the first adhesive layer 1126 is composed of thermosetting polyolefin, thermosetting polyolefin encapsulant material, thermosetting ethylene-vinyl acetate (EVA), EVA encapsulants, thermoplastic olefin, thermoplastic polyolefin (TPO) or hybrids/combinations thereof. In some embodiments, the first adhesive layer 1126 has a thickness of 0.2 mm to 2 mm. In some embodiments, the first adhesive layer 1126 has a thickness of 1 μm to 900 μm.

In some embodiments, the polymer layer 1124 is composed of a fluoropolymer. In certain embodiments, the fluoropolymer may be ethylene tetrafluoroethylene (ETFE), fluoropolymer is polyvinylidene fluoride (PVDF), tetrafluoroethylene-hexafluoropropylene copolymers (FEP), and tetrafluoroethylene-hexafluoropropylene-vinylidene fluoride copolymers (THV), polyvinyl fluoride (PVF), or blends thereof. In some embodiments, the frontsheet is composed of fluoropolymers, acrylics, polyesters, silicones, polycarbonates, or combinations thereof. In some embodiments, the polymer layer 1124 is composed of polyethylene terephthalate (PET), polyethylene naphthalate (PEN), polyetheretherketone (PEEK), polyaryletherketone (PAEK), polyarylate (PAR), polyetherimide (PEI), polyarylsulfone (PAS), polyethersulfone (PES), polyamideimide (PAI), polyphenylsulfone (PPSU), polyolefin, cyclic olefin copolymers (CPCs), or polyimide. In some embodiments, the polymer layer 1124 is composed of a crosslinked polymeric material. In some embodiments, 50% to 99% of the polymer chains of the polymeric material are crosslinked. In some embodiments, the polymer layer 1124 has a thickness of 0.01 mm to 0.5 mm.

In some embodiments, a backsheet 1128 is juxtaposed with a second layer 1114b of the encapsulant 1114. In some embodiments, the backsheet 1128 includes a first layer 1130 and a second layer 1132. In some embodiments, the first layer 1130 is juxtaposed with the second layer 1114b of the encapsulant 1114. In some embodiments, the second layer 1132 is juxtaposed with the first layer 1130. In some embodiments, the first layer 1130 of the backsheet 1128 is composed of a polymeric material. In some embodiments, the first layer 1130 of the backsheet 1128 is composed of polyethylene terephthalate (“PET”). In some embodiments, the first layer 1130 of the backsheet 1128 is composed of ethylene tetrafluoroethylene (“ETFE”). In some embodiments, the first layer 1130 of the backsheet 1128 is composed of an acrylic such as polymethyl methacrylate (“PMMA”). In some embodiments, the first layer 1130 of the backsheet 1128 is composed of thermoplastic polyolefin (TPO). In some embodiments, the first layer 1130 of the backsheet 1128 includes of a single ply TPO roofing membrane. In some embodiments, non-limiting examples of TPO membranes are disclosed in U.S. Pat. No. 9,359,014 to Yang et al., which is incorporated by reference herein in its entirety. In some embodiments, the first layer 1130 of the backsheet 1128 is composed of polyvinyl chloride. In some embodiments, the first layer 1130 of the backsheet 1128 is composed of ethylene propylene diene monomer (EPDM) rubber. In some embodiments, the first layer 1130 of the backsheet 1128 includes a flame retardant additive. In some embodiments, the flame retardant additive may be clays, nanoclays, silicas, carbon black, metal hydroxides such as aluminum hydroxide, metal foils, graphite, and combinations thereof. In some embodiments, the first layer 1130 has a thickness of 0.2 mm to 0.5 mm.

In some embodiments, the second layer 1132 of the backsheet 1128 is composed of a polymeric material. In some embodiments, the second layer 1132 of the backsheet 1128 is composed of thermoplastic polyolefin (TPO). In some embodiments, the second layer 1132 of the backsheet 1128 includes a single ply TPO roofing membrane. In some embodiments, non-limiting examples of TPO membranes are disclosed in U.S. Pat. No. 9,359,014 to Yang et al., which is incorporated by reference herein in its entirety. In some embodiments, the second layer 1132 of the backsheet 1128 is composed of polyethylene terephthalate (“PET”). In some embodiments, the second layer 1132 is composed of styrene acrylic copolymer. In some embodiments, the second layer 1132 of the backsheet 1128 is composed of ethylene tetrafluoroethylene (“ETFE”). In some embodiments, the second layer 1132 of the backsheet 1128 is composed of an acrylic such as polymethyl methacrylate (“PMMA”). In some embodiments, the second layer 1132 of the backsheet 1128 is composed of polyvinyl chloride. In some embodiments, the second layer 1132 of the backsheet 1128 is composed of ethylene propylene diene monomer (EPDM) rubber. In some embodiments, the second layer 1132 of the backsheet 1128 includes a flame retardant additive. In some embodiments, the flame retardant additive may be clays, nanoclays, silicas, carbon black, metal hydroxides such as aluminum hydroxide, metal foils, graphite, and combinations thereof.

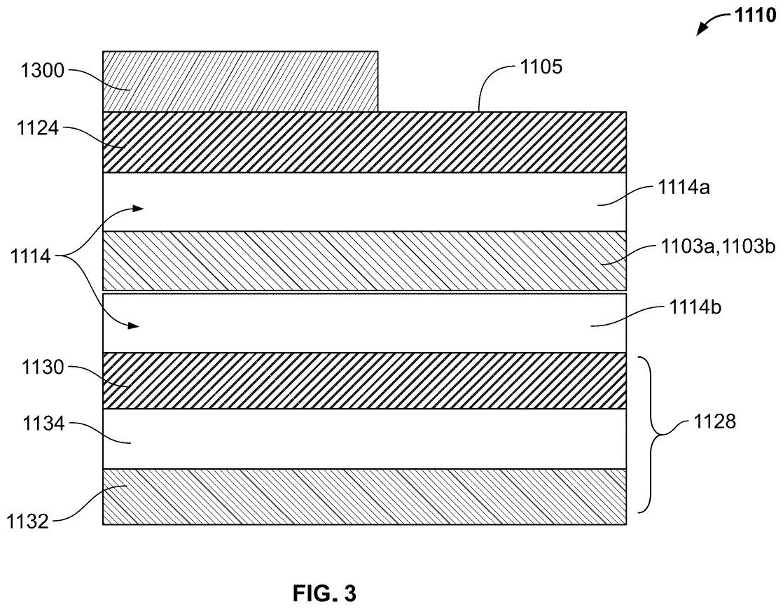

FIG. 3 shows a schematic view of the first side lap 1115. In some embodiments, the first side lap 1115 includes a structure and materials similar to those of the active area 1109, with certain differences. In some embodiments, the first side lap 1115 includes ends of the bussing wires 1103a, 1103b encapsulated by the encapsulant 1114. In some embodiments, the first side lap 1115 includes the polymer layer 1124. In some embodiments, the polymer layer 1124 is an upper, sun facing-side surface of the first side lap 1115. In some embodiments, the second side lap 1117 includes a structure and materials similar to those as the first side lap 1115. In some embodiments, the head lap portion 1113 includes a structure and materials similar to those as the first side lap 1115.

In some embodiments, the wire cover bracket 1300 is located on a surface 1105 of the polymer layer 1124. In some embodiments, the wire cover bracket 1300 is composed of a polymer. In some embodiments, the wire cover bracket 1300 is composed of a composite material. In some embodiments, the wire cover bracket 1300 is composed of a reinforced plastic. In some embodiments, the wire cover bracket 1300 is composed of a fiber-reinforced polymer. In some embodiments, the wire cover bracket 1300 is composed of fiberglass. In some embodiments, the wire cover bracket 1300 is injection molded. In some embodiments, the wire cover bracket 1300 is configured to receive a cover 1304, which shall be described in detail hereinafter. In some embodiments, the wire cover bracket 1300 is attached to the surface 1105 of the polymer layer 1124 by an adhesive. In some embodiments, the wire cover bracket 1300 is attached to the surface 1105 of the polymer layer 1124 by thermal bonding. In some embodiments, the wire cover bracket 1300 is attached to the surface 1105 of the polymer layer 1124 by ultrasonic welding. In some embodiments, the wire cover bracket 1300 has a height of 1 mm to 10 mm.

In some embodiments, the first layer 1130 is attached to the second layer 1132 by a second adhesive layer 1134. In some embodiments, the second adhesive layer 1134 may include polyvinyl butyrate, acrylic, silicone, or polycarbonate. In some embodiments, the second adhesive layer 1134 may include pressure sensitive adhesives. In some embodiments, the second adhesive layer 1134 is composed of thermosetting polyolefin, thermosetting polyolefin encapsulant material, thermosetting ethylene-vinyl acetate (EVA), EVA encapsulants, thermoplastic olefin, thermoplastic polyolefin (TPO) or hybrids/combinations thereof. In some embodiments, the second adhesive layer 1134 has a thickness of 0.2 mm to 2 mm. In some embodiments, the second adhesive layer 1134 has a thickness of 1 μm to 900 μm.

In some embodiments, the first layer 1130 is attached to the second layer 1132 by thermal bonding. In some embodiments, each of the plurality of photovoltaic modules 1110 is installed on the roof deck by an adhesive. In some embodiments, the adhesive is adhered directly to the roof deck. In some embodiments, the adhesive is adhered to an underlayment. In some embodiments, the underlayment is adhered directly to the roof deck. In some embodiments, the adhesive is located on a rear surface of the photovoltaic module 1110. In some embodiments, the adhesive is located on the second layer 1132 of the backsheet 1128. In some embodiments, the adhesive includes at least one adhesive strip. In some embodiments, the adhesive includes a plurality of adhesive strips. In some embodiments, the plurality of adhesive strips is arranged intermittently. In some embodiments, the adhesive is located proximate to one edge of the photovoltaic module 1110. In some embodiments, the adhesive is a peel and stick film sheet. In some embodiments, the peel and stick film sheet includes at least one sheet of film removably attached to the rear surface. In some embodiments, the peel and stick film sheet is composed of EverGuard Freedom HW peel and stick membrane manufactured by GAF. In some embodiments, the adhesive includes polyvinyl butyrate, acrylic, silicone, or polycarbonate. In some embodiments, the adhesive includes pressure sensitive adhesives.

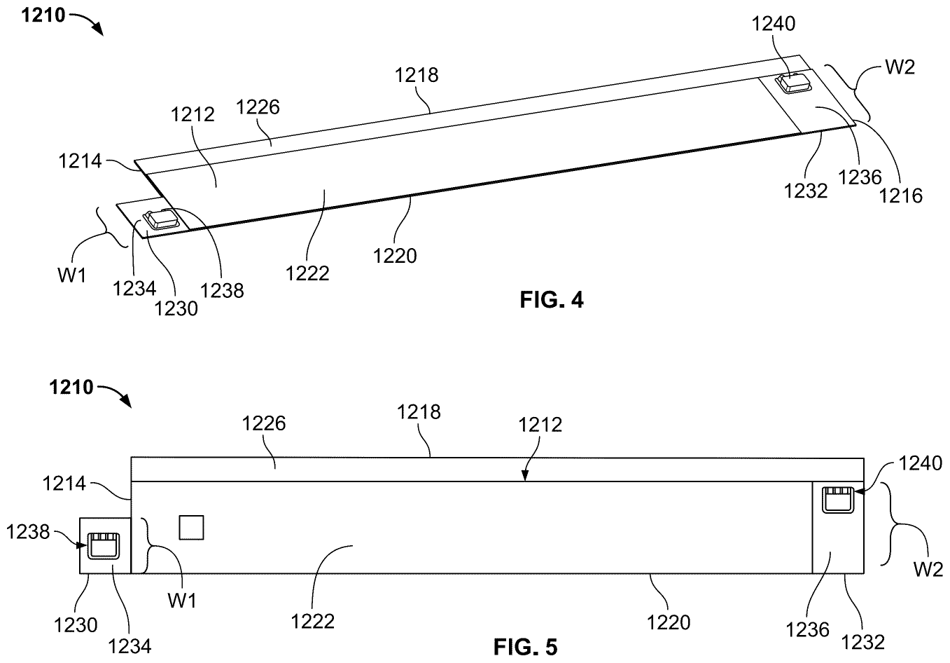

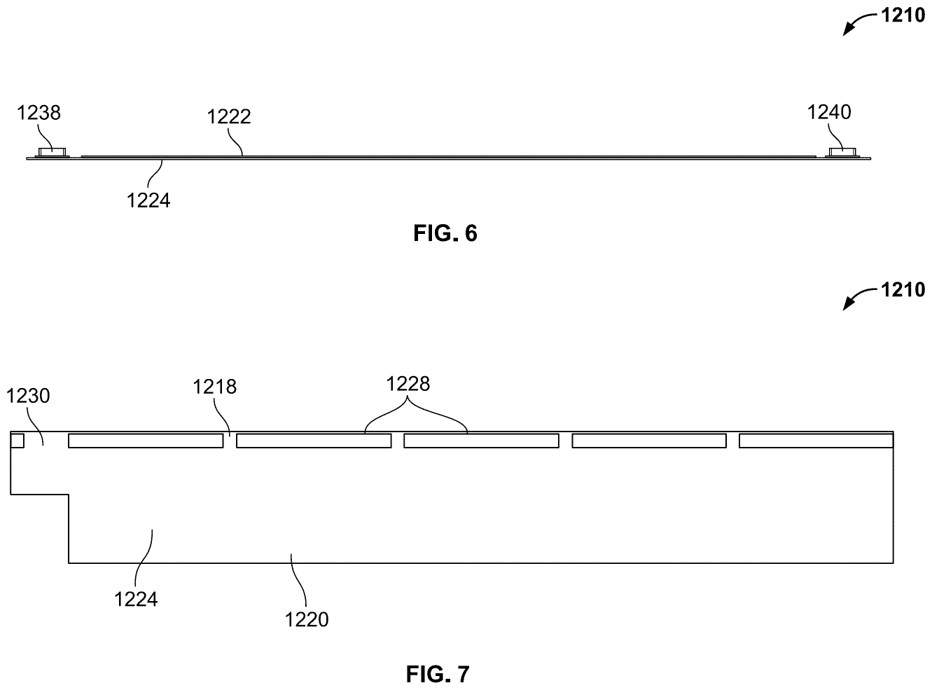

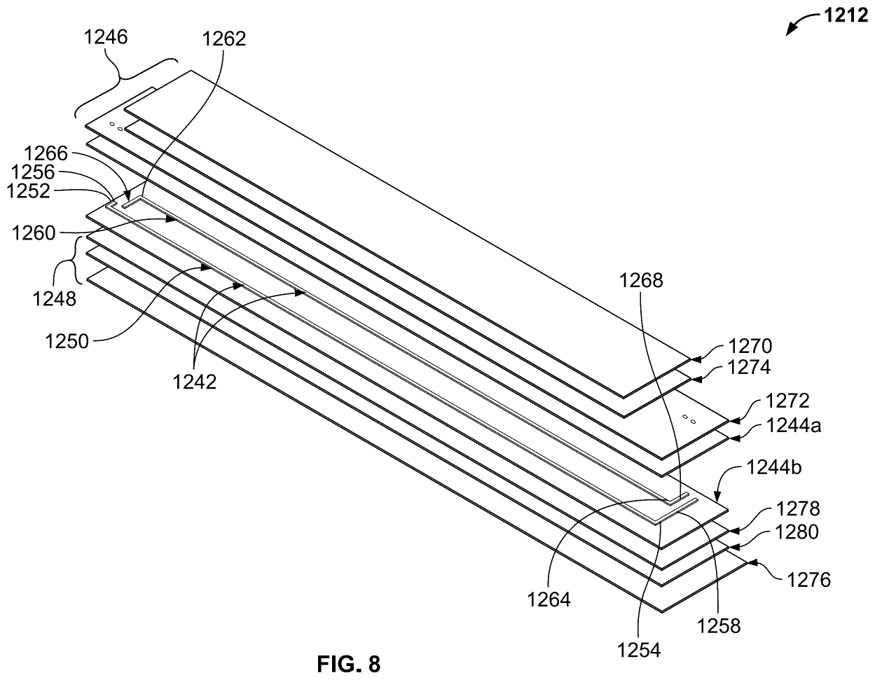

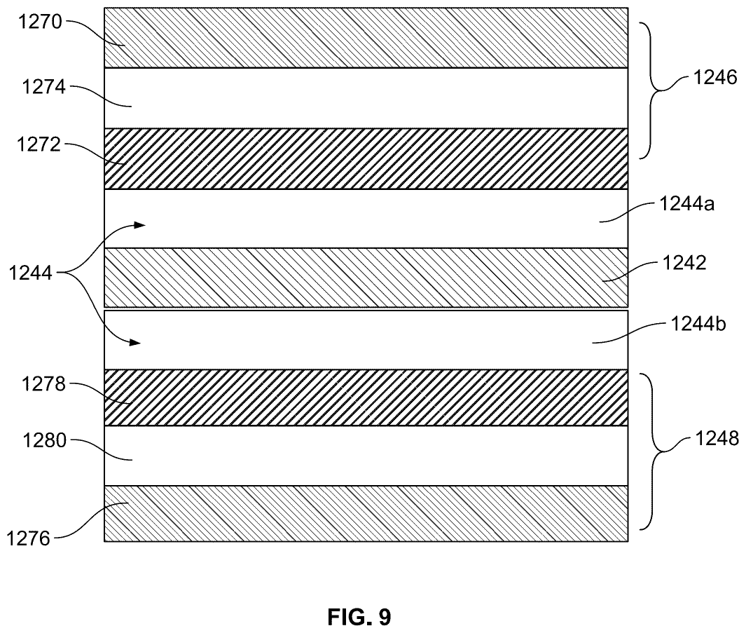

Referring to FIGS. 4 through 9, in some embodiments, a jumper module 1210 includes an active portion 1212 having a first end 1214, a second end 1216 opposite the first end 1214, a first edge 1218 extending from the first end 1214 to the second end 1216, and a second edge 1220 opposite the first edge 1218 and extending from the first end 1214 to the second end 1216. In some embodiments, the active portion 1212 includes a first surface 1222 and a second surface 1224 opposite the first surface 1222. In some embodiments, the jumper module 1210 is configured to be installed on a roof deck. In some embodiments, the jumper module 1210 is installed on the roof deck by a plurality of fasteners. In some embodiments, the active portion 1212 includes a first zone 1226 (nail zone) that extends from the first end 1214 to the second end 1216 and from the first edge 1218 to a location intermediate the first edge 1218 and the second edge 1220. In some embodiments, the first zone 1226 is configured to receive the plurality of fasteners. In some embodiments, the plurality of fasteners is installed through the first zone 1226. In some embodiments, the plurality of fasteners includes a plurality of nails. In some embodiments, the plurality of fasteners includes a plurality of rivets. In some embodiments, the plurality of fasteners includes a plurality of staples. In some embodiments, the plurality of fasteners includes a plurality of screws.

In some embodiments, the jumper module 1210 is installed on the roof deck by an adhesive 1228. In some embodiments, the adhesive 1228 is adhered to the head lap portion 1113 of a photovoltaic module 1110 below the jumper module 1210. In some embodiments, the adhesive 1228 is adhered directly to the roof deck. In some embodiments, the adhesive 1228 is adhered to an underlayment. In some embodiments, the underlayment is adhered directly to the roof deck. In some embodiments, the adhesive 1228 includes at least one adhesive strip. In some embodiments, the adhesive 1228 includes a plurality of adhesive strips. In some embodiments, the adhesive 1228 is located on the second surface 1224. In some embodiments, the adhesive 1228 is located proximate to the first edge 1218. In some embodiments, the adhesive 1228 is located intermediate the first edge 1218 and the second edge 1220. In some embodiments, the adhesive 1228 is located proximate to the second edge 1220. In some embodiments, the adhesive 1228 is a peel and stick film sheet. In some embodiments, the peel and stick film sheet includes at least one sheet of film removably attached to the second surface 1224. In some embodiments, the peel and stick film sheet is composed of EverGuard Freedom HW peel and stick membrane manufactured by GAF. In some embodiments, the adhesive 1228 is covered by a release liner. In some embodiments, the release liner includes paper with a silicone coating. In some embodiments, the adhesive 1228 includes polyvinyl butyrate, butyl, acrylic, silicone, or polycarbonate. In some embodiments, the adhesive 1228 includes pressure sensitive adhesives.

Still referring to FIGS. 4 through 9, in some embodiments, the jumper module 1210 includes a first side lap 1230 located the first end 1214. In some embodiments, the jumper module 1210 includes a second side lap 1232 located at the second end 1216. In some embodiments, the first side lap 1230 includes a surface 1234. In some embodiments, the second side lap 1232 includes a surface 1236. In some embodiments, the first side lap 1230 is square in shape. In some embodiments, the first side lap 1230 is rectangular in shape. In some embodiments, the first side lap 1230 includes other suitable shapes and sizes. In some embodiments, the second side lap 1232 is square in shape. In some embodiments, the second side lap 1232 is rectangular in shape. In some embodiments, the second side lap 1232 includes other suitable shapes and sizes. In some embodiments, the first side lap 1230 is integral with the active portion 1212. In some embodiments, the first side lap 1230 is a separate component from the active portion 1212. In some embodiments, the first side lap 1230 is attached to the active portion 1212. In some embodiments, the second side lap 1232 is integral with the active portion 1212. In some embodiments, the second side lap 1232 is a separate component from the active portion 1212. In some embodiments, the second side lap 1232 is attached to the active portion 1212.

In some embodiments, the first side lap 1230 includes a first width W1. In some embodiments, the first width W1 extends from the second edge 1220 to a location intermediate the first edge 1218 and the second edge 1220. In some embodiments, the second side lap 1232 includes a second width W2. In some embodiments, the second width W2 extends from the first edge 1218 to the second edge 1220. In some embodiments, the width W1 of the first side lap 1230 is approximately half the width W2 of the second side lap 1232. In some embodiments, the width W1 of the first side lap 1230 is 70 mm to 120 mm. In some embodiments, the width W2 of the second side lap 1232 is 70 mm to 200 mm.

In some embodiments, the jumper module 1210 includes a first junction box 1238. In some embodiments, the first junction box 1238 is located on the surface 1234 of the first side lap 1230. In some embodiments, the first junction box 1238 is attached to the surface 1234 by an adhesive. In some embodiments, the first junction box 1238 is encapsulated by the first side lap 1230. In some embodiments, the jumper module 1210 includes a second junction box 1240. In some embodiments, the second junction box 1240 is located on the surface 1236 of the second side lap 1232. In some embodiments, the second junction box 1240 is attached to the surface 1236 by an adhesive. In some embodiments, the second junction box 1240 is encapsulated by the second side lap 1232. In certain embodiments, other electronic and electrical components may be attached to the first side lap 1230 and/or the second side lap 1232. In some embodiments, non-limiting examples of such electronic and electrical components include an electrical connector, a rapid shutdown device, an optimizer, and a microinverter. In some embodiments, the electrical connector includes a flat wire connector.

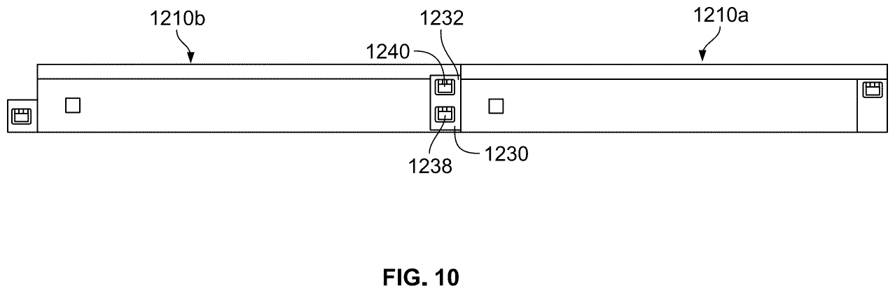

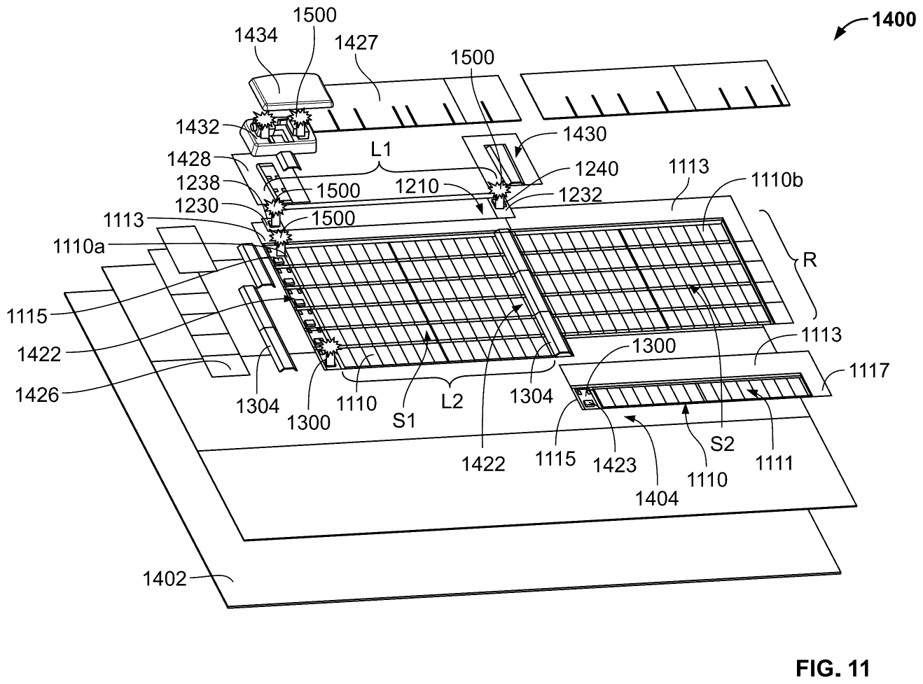

Referring to FIGS. 8 and 9, in some embodiments, the active portion 1212 is a laminated structure. In some embodiments, the active portion 1212 includes electrical bussing 1242, an encapsulant 1244 encapsulating the electrical bussing 1242, a frontsheet 1246 juxtaposed with the encapsulant 1244, and a backsheet 1248 juxtaposed with the encapsulant 1244. As used herein, the terms “encapsulating” and “encapsulates” mean to partially or fully envelope or enclose, and with respect to certain embodiments of the jumper module 1210, the electrical bussing 1242 is fully enveloped by or enclosed within the encapsulant 1244, or partially enveloped by or enclosed within the encapsulant 1244. In some embodiments, the encapsulant 1244 includes a first layer 1244a and a second layer 1244b. In some embodiments, the encapsulant 1244 includes a structure and/or materials that is similar to the encapsulant 1114.

In some embodiments, the electrical bussing 1242 includes a first bus ribbon 1250 extending from a first end 1252 proximate to the first end 1214 and a second end 1254 proximate to the second end 1216. In some embodiments, the first bus ribbon 1250 includes a first terminal 1256 located at the first end 1252 and a second terminal 1258 located at the second end 1254. In some embodiments, the first terminal 1256 is a positive terminal, while the second terminal 1258 is a negative terminal. In some embodiments, the first terminal 1256 is a negative terminal, while the second terminal 1258 is a positive terminal.

In some embodiments, the electrical bussing 1242 includes a second bus ribbon 1260 extending from a first end 1262 proximate to the first end 1214 and a second end 1264 proximate to the second end 1216. In some embodiments, the second bus ribbon 1260 includes a first terminal 1266 located at the first end 1262 and a second terminal 1268 located at the second end 1264. In some embodiments, the first terminal 1266 is a negative terminal, while the second terminal 1268 is a positive terminal. In some embodiments, the first terminal 1266 is a positive terminal, while the second terminal 1268 is a negative terminal.

In some embodiments, the encapsulant 1244 may be composed of polyolefins, ethyl vinyl acetates, ionomers, silicones, poly vinyl butyral, epoxies, polyurethanes, or combinations/hybrids thereof. In some embodiments, the encapsulant 1244 is composed of thermosetting polyolefin.

In some embodiments, the encapsulant 1244 has a thickness of 0.4 mm to 1.8 mm. In some embodiments, the encapsulant 1244 has a thickness similar to those of the encapsulant 1114 of the photovoltaic module 1110 described above. In some embodiments, the first layer 1244a of the encapsulant 1244 has a thickness of 0.2 mm to 0.9 mm. In some embodiments, the first layer 1244a of the encapsulant 1244 has a thickness similar to those of the first layer 1114a of the encapsulant 1114 described above. In some embodiments, the second layer 1244b of the encapsulant 1244 has a thickness of 0.2 mm to 0.9 mm. In some embodiments, the second layer 1244b of the encapsulant 1244 has a thickness similar to those of the second layer 1114b of the encapsulant 1114 described above. In some embodiments, the thickness of the first layer 1244a is equal to the thickness of the second layer 1244b. In some embodiments, the thickness of the first layer 1244a is different from the thickness of the second layer 1244b.

In some embodiments, the first layer 1244a is white in color. In some embodiments, the second layer 1244b is white in color.

In some embodiments, the frontsheet 1246 includes an upper layer 1270 and a polymer layer 1272 attached to the upper layer 1270. In some embodiments, the frontsheet 1246 is juxtaposed with the first layer 1244a of the encapsulant 1244. In some embodiments, the polymer layer 1272 is attached to the upper layer 1270 by an adhesive layer 1274. In some embodiments, the adhesive layer 1274 may include polyvinyl butyrate, acrylic, silicone, or polycarbonate. In some embodiments, the adhesive layer 1274 may include pressure sensitive adhesives. In some embodiments, the polymer layer 1272 is attached to the upper layer 1270 by thermal bonding. In some embodiments, the frontsheet 1246 includes at least one of the upper layer 1270 or the polymer layer 1272. In some embodiments, the upper layer 1270 is an upper, sun facing-side surface of the jumper module 1210.

In some embodiments, the upper layer 1270 is composed of thermoplastic polyolefin (TPO). In some embodiments, the upper layer 1270 includes a single ply TPO roofing membrane. In some embodiments, the upper layer 1270 is colored black. In some embodiments, non-limiting examples of TPO membranes are disclosed in U.S. Pat. No. 9,359,014 to Yang et al., which is incorporated by reference herein in its entirety.

In some embodiments, the upper layer 1270 is composed of polyvinyl chloride (PVC). In some embodiments, the upper layer 1270 is composed of ethylene propylene diene monomer (EPDM) rubber. In some embodiments, the upper layer 1270 includes a flame retardant additive. In some embodiments, the flame retardant additive may be clays, nanoclays, silicas, carbon black, metal hydroxides such as aluminum hydroxide, metal foils, graphite, and combinations thereof. In some embodiments, the upper layer 1270 is white in color. In some embodiments, the upper layer 1270 has a thickness of 2.5 mm to 4 mm.

In some embodiments, the adhesive layer 1274 is composed of thermosetting polyolefin, thermosetting polyolefin encapsulant material, thermosetting ethylene-vinyl acetate (EVA), EVA encapsulants, thermoplastic olefin, thermoplastic polyolefin (TPO) or hybrids/combinations thereof. In some embodiments, the adhesive layer 1274 is white in color.

In some embodiments, the adhesive layer 1274 has a thickness of 1 μm to 900 μm. In some embodiments, the adhesive layer 1274 has a thickness similar to those of the first adhesive layer 1126 of the photovoltaic module 1110 described above. In some embodiments, the adhesive layer 1274 has a structure and/or is composed of materials similar to the first adhesive layer 1126.

In some embodiments, the frontsheet 1246 does not include the upper layer 1270 or the adhesive layer 1274.

In some embodiments, the polymer layer 1272 is composed of a fluoropolymer. In certain embodiments, the fluoropolymer may be ethylene tetrafluoroethylene (ETFE), fluoropolymer is polyvinylidene fluoride (PVDF), tetrafluoroethylene-hexafluoropropylene copolymers (FEP), and tetrafluoroethylene-hexafluoropropylene-vinylidene fluoride copolymers (THV), polyvinyl fluoride (PVF), or blends thereof. In some embodiments, the frontsheet is composed of fluoropolymers, acrylics, polyesters, silicones, polycarbonates, or combinations thereof. In some embodiments, the polymer layer 1272 is composed of polyethylene terephthalate (PET), polyethylene naphthalate (PEN), polyetheretherketone (PEEK), polyaryletherketone (PAEK), polyarylate (PAR), polyetherimide (PEI), polyarylsulfone (PAS), polyethersulfone (PES), polyamideimide (PAI), polyphenylsulfone (PPSU), polyolefin, cyclic olefin copolymers (CPCs), or polyimide. In some embodiments, the polymer layer 1272 is composed of a crosslinked polymeric material. In some embodiments, 50% to 99% of the polymer chains of the polymeric material are crosslinked. In some embodiments, the polymer layer 1272 is white in color. In some embodiments, the polymer layer 1272 has a thickness of 0.01 mm to 0.5 mm.

In some embodiments, the backsheet 1248 includes a lower layer 1276. In some embodiments, the backsheet 1248 includes a polymer layer 1278. In some embodiments, the lower layer 1276 and the polymer layer 1278 are attached to one another by an adhesive layer 1280. In some embodiments, the adhesive layer 1280 may include polyvinyl butyrate, acrylic, silicone, or polycarbonate. In some embodiments, the adhesive layer 1280 may include pressure sensitive adhesives. In some embodiments, the adhesive layer 1280 is composed of thermosetting polyolefin, thermosetting polyolefin encapsulant material, thermosetting ethylene-vinyl acetate (EVA), EVA encapsulants, thermoplastic olefin, thermoplastic polyolefin (TPO) or hybrids/combinations thereof. In some embodiments, the adhesive layer 1280 is white in color. In some embodiments, the lower layer 1276 is attached to the polymer layer 1278 by thermal bonding. In some embodiments, the backsheet 1248 includes at least one of the lower layer 1276 or the polymer layer 1278. In some embodiments, the lower layer 1276 is a lower surface of the jumper module 1210 configured to face a roof deck on which the jumper module 1210 is installed. In some embodiments, the lower layer 1276 is composed of thermoplastic polyolefin (TPO). In some embodiments, the lower layer 1276 includes a single ply TPO roofing membrane. In some embodiments, the lower layer 1276 is colored black. In some embodiments, non-limiting examples of TPO membranes are disclosed in U.S. Pat. No. 9,359,014 to Yang et al., which is incorporated by reference herein in its entirety.

In some embodiments, the lower layer 1276 is composed of polyvinyl chloride. In some embodiments, the lower layer 1276 is composed of ethylene propylene diene monomer (EPDM) rubber. In some embodiments, the lower layer 1276 includes a flame retardant additive. In some embodiments, the flame retardant additive may be clays, nanoclays, silicas, carbon black, metal hydroxides such as aluminum hydroxide, metal foils, graphite, and combinations thereof. In some embodiments, the lower layer 1276 is white in color. In some embodiments, the lower layer 1276 has a thickness of 2.5 mm to 4 mm.

In some embodiments, the backsheet 1248 does not include the lower layer 1276 or the adhesive layer 1280. In some embodiments, the frontsheet 1246 does not include the upper layer 1270 or the adhesive layer 1274 and the backsheet 1248 does not include the lower layer 1276 or the adhesive layer 1280.

In some embodiments, the polymer layer 1278 is composed of a fluoropolymer. In certain embodiments, the fluoropolymer may be ethylene tetrafluoroethylene (ETFE), fluoropolymer is polyvinylidene fluoride (PVDF), tetrafluoroethylene-hexafluoropropylene copolymers (FEP), and tetrafluoroethylene-hexafluoropropylene-vinylidene fluoride copolymers (THV), polyvinyl fluoride (PVF), or blends thereof. In some embodiments, the frontsheet is composed of fluoropolymers, acrylics, polyesters, silicones, polycarbonates, or combinations thereof. In some embodiments, the polymer layer 1278 is composed of polyethylene terephthalate (PET), polyethylene naphthalate (PEN), polyetheretherketone (PEEK), polyaryletherketone (PAEK), polyarylate (PAR), polyetherimide (PEI), polyarylsulfone (PAS), polyethersulfone (PES), polyamideimide (PAI), polyphenylsulfone (PPSU), polyolefin, cyclic olefin copolymers (CPCs), or polyimide. In some embodiments, the polymer layer 1278 is composed of a crosslinked polymeric material. In some embodiments, 50% to 99% of the polymer chains of the polymeric material are crosslinked. In some embodiments, the polymer layer 1278 is white in color. In some embodiments, the polymer layer 1278 has a thickness of 0.01 mm to 0.5 mm. In some embodiments, the adhesive layer 1280 has a thickness of 1 μm to 900 μm. In some embodiments, the jumper module 1210 has a thickness of 1 mm to 10 mm.

In some embodiments, the jumper module 1210 is moisture resistant. As used herein, the term “moisture resistant” means having a water transmission rate of less than or equal to 0.05 U.S. perms, as measured by ASTM E 96, Procedure B-Standard Test Methods for Water Vapor Transmission of Materials. In some embodiments, the jumper module 1210 withstands walking loads/step resistance that conforms to standards under UL 3741 test standards (UL Standard for Safety Photovoltaic Hazard Control). In some embodiments, the jumper module 1210 includes an axe impact resistance that conforms to standards under UL 3741 test standards. In some embodiments, the jumper module 1210 includes a body fall resistance that conforms to standards under UL 3741 test standards.

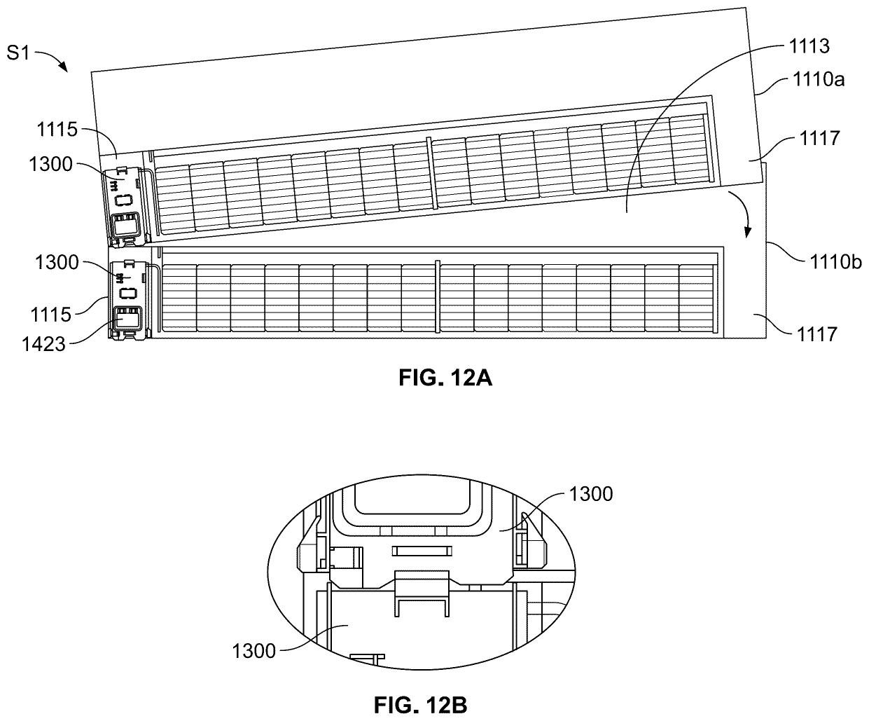

Referring to FIG. 10, in some embodiments, one of the jumper module 1210a is configured to overlay another one of the jumper module 1210b. In some embodiments, the first side lap 1230 of the jumper module 1210a overlays the second side lap 1232 of the jumper module 1210b. In some embodiments, the first side lap 1230 of the jumper module 1210a is attached to the second side lap 1232 of the jumper module 1210b. In some embodiments, the first side lap 1230 of the jumper module 1210a is attached to the second side lap 1232 of the jumper module 1210b by an adhesive. In some embodiments, the first side lap 1230 of the jumper module 1210a is attached to the second side lap 1232 of the jumper module 1210b by thermal bonding. In some embodiments, the first side lap 1230 of the jumper module 1210a is attached to the second side lap 1232 of the jumper module 1210b by ultrasonic welding. In some embodiments, the first side lap 1230 of the jumper module 1210a is attached to the second side lap 1232 of the jumper module 1210b by at least one fastener. In some embodiments, the first junction box 1238 of the jumper module 1210a is positioned proximate to the second junction box 1240 of the jumper module 1210b. In some embodiments, the first junction box 1238 and the second junction box 1240 are arranged in a linear array.

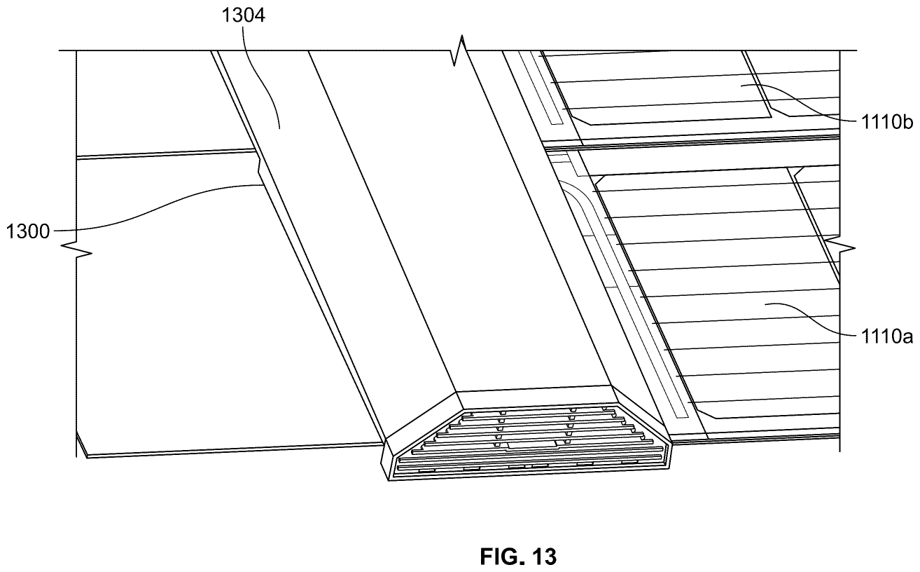

Referring to FIG. 11, in some embodiments, a photovoltaic system 1400 includes an underlayment layer 1404 installed on a roof deck 1402. In some embodiments, the photovoltaic system 1400 includes a plurality of the photovoltaic modules 1110. In some embodiments, the plurality of photovoltaic modules 1110 overlay the underlayment layer 1404. In some embodiments, the photovoltaic modules 1110 are arranged in an array on the roof deck 1402. In some embodiments, the array of the photovoltaic modules 1110 includes subarrays S1, S2. In certain embodiments, the array includes more than the two subarrays S1, S2. In some embodiments, the array includes a single array S1. In some embodiments, each of the subarrays S1, S2 include a plurality of rows R of the photovoltaic modules 1110.

In some embodiments, the photovoltaic system 1400 includes at least one indicator 1500. In some embodiments, the at least one indicator 1500 is electrically connected to the photovoltaic modules 1110. In some embodiments, the at least one indicator 1500 is configured to visually indicate at least one electrically active component of the photovoltaic system 1400. In some embodiments, the at least one indicator 1500 includes a plurality of indicators 1500. In some embodiments, the indicator 1500 is a visible indicator. In some embodiments, the visible indicator is an illuminated light source. In some embodiments, the illuminated light source is a light emitting diode (LED). In some embodiments, the light emitting diode is a colored light emitting diode (LED). In some embodiments, the indicator 1500 is configured to provide a steady or constant illumination. In some embodiments, the indicator 1500 is configured to provide intermittent illumination (e.g., a flashing light). In some embodiments, the intermittent illumination is patterned. In some embodiments, the intermittent illumination is random. In some embodiments, the voltage difference (between Voc and Vmp) is utilized to toggle a state machine and turn on or off the indicator 1500. In some embodiments, locations of the at least one indicator 1500 is described hereinbelow.

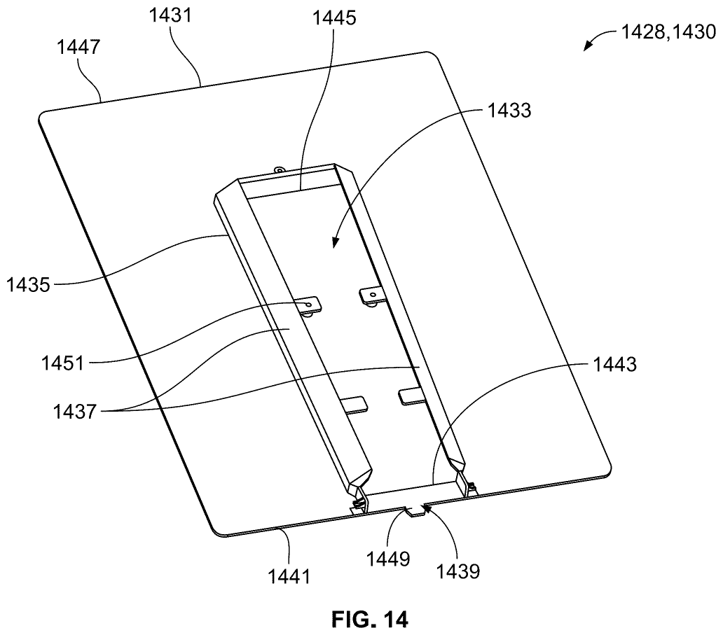

Referring to FIGS. 12A and 12B, in some embodiments, the reveal portion 1111 of one 1110a of the photovoltaic modules 1110 in the subarray S1 overlays the head lap portion 1113 of an adjacent another one of the photovoltaic modules 1110b of the subarray S1. In some embodiments, at least a portion of the first side lap 1115 of the one of the photovoltaic modules 1110a overlays at least a portion of the first side lap 1115 of the another one of the photovoltaic modules 1110b. In some embodiments, at least a portion of the second side lap 1117 of the one of the photovoltaic modules 1110a overlays at least a portion of the second side lap 1117 of the another one of the photovoltaic modules 1110b. In some embodiments, the wire cover bracket 1300 of the photovoltaic module 1110a overlaps the wire cover bracket 1300 of the photovoltaic module 1110b.

In some embodiments, the overlay of the first side laps 1115 form at least one wireway 1422. In some embodiments, the at least one wireway 1422 includes a plurality of wireways. In some embodiments, the at least one wireway 1422 includes a plurality of the wire cover brackets 1300. In some embodiments, the wire cover brackets 1300 are aligned in a column.

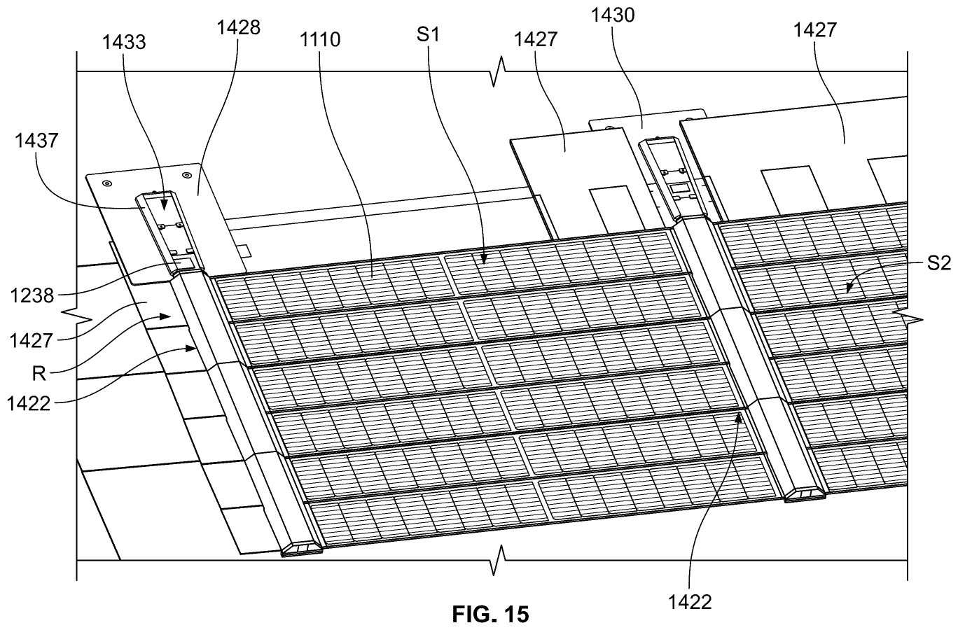

Referring to FIGS. 11 and 13, in some embodiments, at least one of the cover 1304 is attached to at least a corresponding one of the wire cover brackets 1300. In some embodiments, the at least one cover 1304 is removably attached to at least a corresponding one of the wire cover brackets 1300. In some embodiments, one of the covers 1304 is attached to a plurality of the wire cover brackets 1300. In some embodiments, the at least one cover 1304 includes a plurality of covers 1304. In some embodiments, each of the plurality of covers 1304 is configured to removably interlock with one another.

With reference to FIG. 11, in some embodiments, the first side lap 1115 of one of the photovoltaic modules 1110 in the subarray S2 overlays the second side lap 1117 of an adjacent another one of the photovoltaic modules 1110 in the subarray S1 in the same one of the rows R. In some embodiments, one of the jumper modules 1210 overlays an uppermost one of the photovoltaic modules 1110a in a column of the subarray S1. In some embodiments, the active portion 1212 of the jumper module 1210 overlays the head lap portion 1113 of the photovoltaic module 1110a. In some embodiments, the active portion 1212 of the jumper module 1210 overlays a portion of the head lap portion 1113 of the photovoltaic module 1110a. In some embodiments, the active portion 1212 of the jumper module 1210 overlays the entirety of the head lap portion 1113 of the photovoltaic module 1110a. In some embodiments, the first side lap 1230 of the jumper module 1210 aligns with the first side lap 1115 of the photovoltaic module 1110a.

In some embodiments, the second side lap 1232 of the jumper module 1210 aligns with the second side lap 1117 of the photovoltaic module 1110a. In some embodiments, the first junction box 1238 of the jumper module 1210 is electrically connected to a junction box 1423 of the photovoltaic module 1110a. In some embodiments, the second junction box 1240 of the jumper module 1210 is electrically connected to the junction box 1423 of another of the photovoltaic modules 1110b. In some embodiments, the jumper module 1210 electrically connects the subarrays S1, S2 of the photovoltaic modules 1110 within the array of the photovoltaic system 1400. In some embodiments, the first bus ribbon 1250 and the second bus ribbon 1260 electrically connect the subarrays of the photovoltaic modules 1110 with one another. In some embodiments, the first bus ribbon 1250 and the second bus ribbon 1260 electrically connect the junction boxes 1423 of the first subarray S1 of the photovoltaic modules 1110 with the junction boxes 1423 of the second subarray S2 of the photovoltaic modules 1110.

In some embodiments, the jumper module 1210 is coplanar with the plurality of photovoltaic modules 1110. As used herein, the term “coplanar” means the jumper module 1210 and the plurality of photovoltaic modules 1110 are positioned and extend within the same plane, or the jumper module 1210 is positioned and extends in a first plane, and the plurality of photovoltaic modules 1110 is positioned and extends within a second plane that is offset from the first plane of no more than ten percent of a height measured from the roof deck 1402 to an upper surface of the jumper module 1210.

In some embodiments, a plurality of step flaps 1426 is installed adjacent to one of the subarrays S1 of the photovoltaic modules 1110. In some embodiments, roofing shingles are configured to overlay the step flaps 1426. In some embodiments, the roofing shingles are asphalt shingles. In some embodiments, the roofing shingles are electrically inactive solar shingles. In some embodiments, a roofing shingle 1427 overlays the active portion 1212 of the jumper module 1210. In some embodiments, another one of the jumper module 1210 overlays the jumper module 1210 of the first subarray, as shown in FIG. 11. In some embodiments, the roofing shingle 1427 conceals the jumper modules 1210. In some embodiments, the roofing shingle 1427 is a watershedding layer. In some embodiments, the roofing shingle 1427 is an asphalt shingle. In some embodiments, the roofing shingle 1427 is located at least 36 inches away from the roof ridge.

In some embodiments, the second side lap 1117 of at least one of the photovoltaic modules 1110 of the subarray S2 overlaps a roofing shingle. In some embodiments, the roofing shingle is an asphalt shingle. In some embodiments, the second layer 1132 of the backsheet 1128 is attached to the roofing shingle by an adhesive. In some embodiments, the adhesive is a butyl adhesive. In some embodiments, a fleece layer and an adhesive are utilized between the second layer 1132 of the backsheet 1128 and the roofing shingle to secure the bonding thereof. In some embodiments, the second layer 1132 of the backsheet 1128 is attached to the roofing shingle by plasma treatment. In some embodiments, the second layer 1132 of the backsheet 1128 is attached to the roofing shingle by a combination of any of the adhesive, the fleece layer and/or plasma treatment. In some embodiments, one or more roofing shingle overlays the second side laps 1117 of the photovoltaic modules 1110 of the subarray S2. In some embodiments, the roofing shingle is an asphalt shingle.

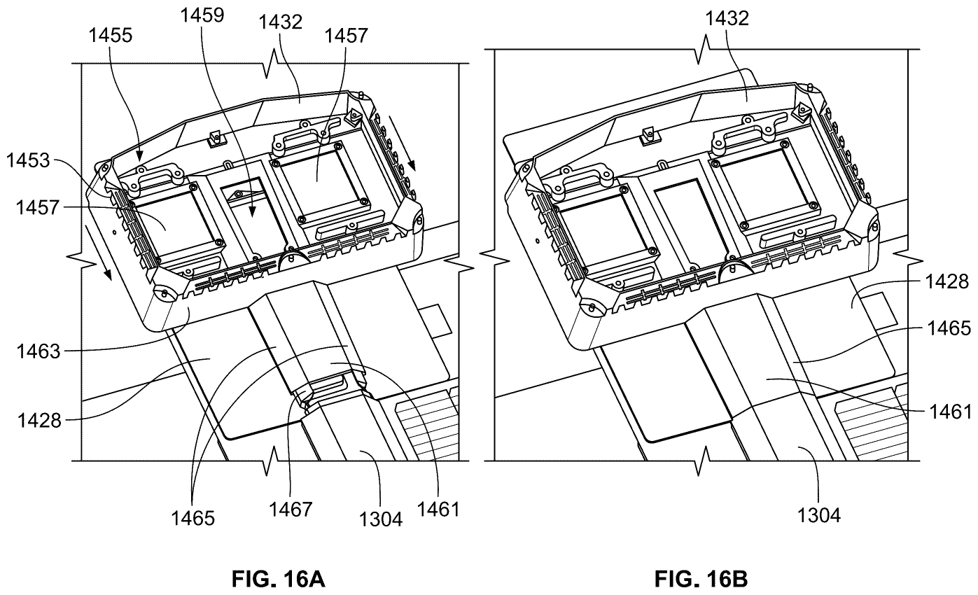

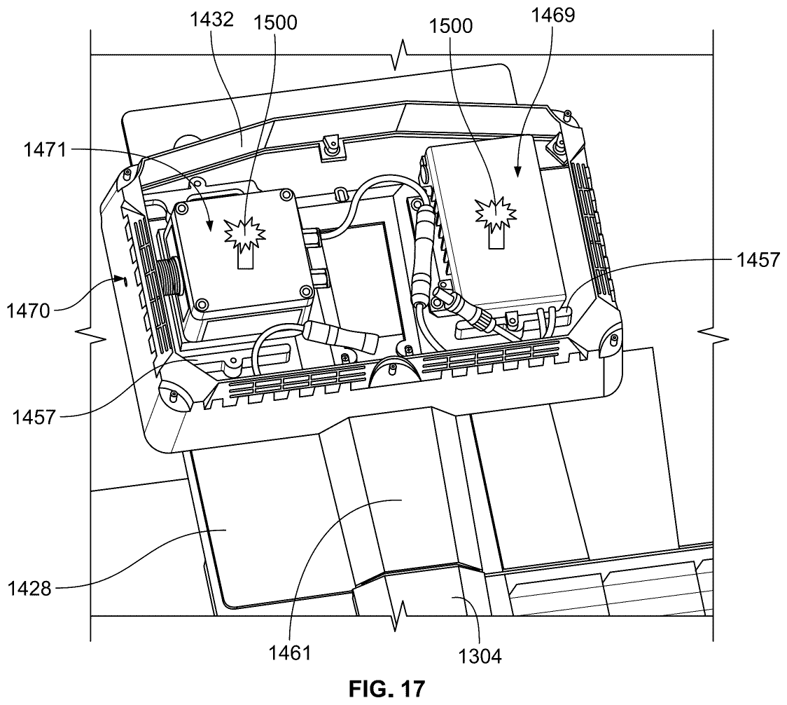

Referring to FIGS. 11, 14 and 15, in some embodiments, the photovoltaic system 1400 includes a first flashing base 1428. In some embodiments, the first flashing base 1428 includes a flat base portion 1431 having a first surface and a second surface opposite the first surface, an aperture 1433 extending from the first surface to the second surface, and a sidewall 1435 extending from the first surface to the second surface and surrounding the aperture 1433. In some embodiments, the base portion 1431 is rectangular in shape. In some embodiments, the base portion 1431 is square in shape. In some embodiments, the base portion 1431 is trapezoidal in shape. In some embodiments, the base portion 1431 is circular in shape. In some embodiments, the sidewall 1435 includes flanged portions 1437 extending obliquely and inwardly. In some embodiments, an opening 1439 is located proximate to a lower end 1441 of the first flashing base 1428. In some embodiments, the aperture 1433 is substantially rectangular in shape. In some embodiments, the aperture 1433 extends from a first end 1443 located proximate to the lower end 1441 of the first flashing base 1428 and a second end 1445 located intermediate the lower end 1441 and an upper end 1447 of the first flashing base 1428. In some embodiments, the aperture 1433 is sized and shaped to receive at least one electrical component therein. In some embodiments, the second end 1445 includes a width that is wider than a width of the first end 1443. In some embodiments, the wider width of the second end 1445 is sized and shaped to receive relatively larger sized electrical components. In some embodiments, the at least one electrical component is the junction box 1238 of the jumper module 1210. In some embodiments, the lower end 1441 of the first flashing base 1428 includes a tab 1449. In some embodiments, screw tabs 1451 are located on the flanged portions 1437 and/or an upper end of the sidewall 1435.

In some embodiments, the first flashing base 1428 is configured to be installed on the roof deck 1402. In some embodiments, the first flashing base 1428 is installed at the top of the wireway 1422 of the subarray S1. In some embodiments, the sidewall 1435, the aperture 1433 and the flanged portions 1437 of the first flashing base 1428 are aligned with the wire cover bracket 1300 of the photovoltaic module 1110 in the uppermost row R of the subarray S1. In some embodiments, the tab 1449 is sized and shaped to contact an end of the wire cover bracket 1300. In some embodiments, a first flashing base 1428 overlays the first side lap 1230 of the jumper module 1210. In some embodiments, the first flashing base is 1428 is configured to be installed to the roof deck 1402 by at least one fastener. In some embodiments, the base portion 1431 is configured to receive the at least one fastener. In some embodiments, the at least one fastener includes a plurality of fasteners. In some embodiments, the plurality of fasteners is roofing nails. In some embodiments, the first flashing base is 1428 is configured to be installed to the roof deck by an adhesive. In some embodiments, the first flashing base 1428 overlays at least one of the step flaps 1426.

In some embodiments, the photovoltaic system 1400 includes a second flashing base 1430. In some embodiments, the second flashing base 1430 has a structure and function similar to those of the first flashing base 1428, with certain differences. In some embodiments, the second flashing base 1430 overlays the second side lap 1232 of the jumper module 1210. In some embodiments, the second flashing base 1430 is installed on the roof deck and is aligned with the wireway 1422 of the second subarray S2 in a manner similar to that of the first flashing base 1428.

In some embodiments, one of the roofing shingles 1427 overlays the base portion 1431 of the first flashing base 1428 on at least one side of the sidewall 1435 thereof. In some embodiments, each of a plurality of the roofing shingles 1427 overlays the base portion 1431 of the first flashing base 1428 on opposite sides of the sidewall 1435. In some embodiments, one of the roofing shingles 1427 overlays the base portion 1431 of the second flashing base 1430 on at least one side of the sidewall 1435 thereof. In some embodiments, each of a plurality of the roofing shingles 1427 overlays the base portion 1431 of the second flashing base 1430 on opposite sides of the sidewall 1435. In some embodiments, the roofing shingles 1427 are asphalt shingles. In some embodiments, the roofing shingles 1427 are composition shingles. In some embodiments, the roofing shingles 1427 are non-asphaltic shingles. In some embodiments, the roofing shingles 1427 are composed of a polymer. In some embodiments, the roofing shingles 1427 are composed of thermoplastic polyolefin (TPO).

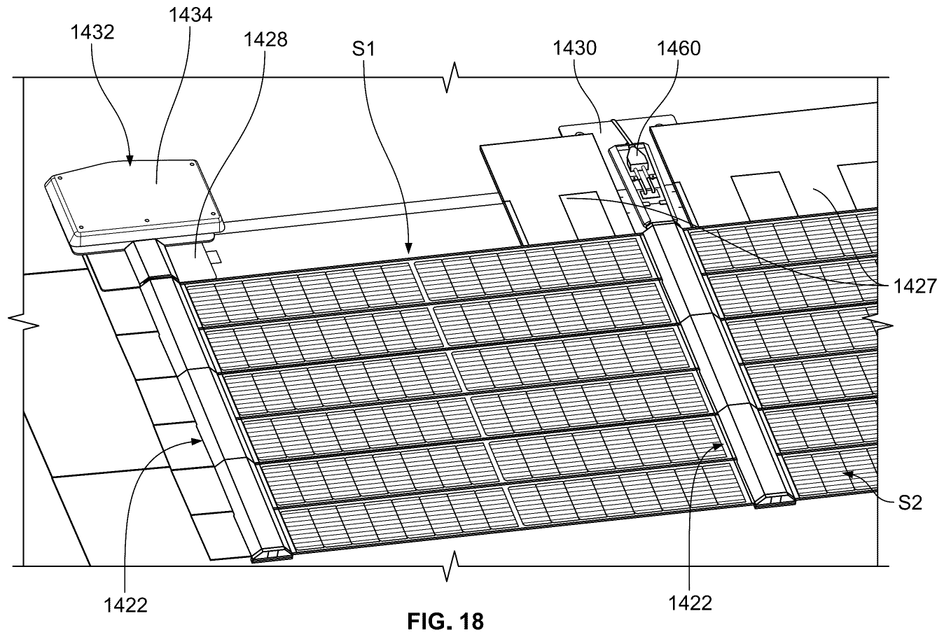

Referring to FIGS. 11 and 16A and 16B, in some embodiments, a transition box 1432 is installed on the first flashing base 1428. In some embodiments, the transition box 1432 includes a housing 1453 having an interior portion 1455. In some embodiments, the interior portion includes at least one base 1457. In some embodiments, the at least one base 1457 is configured to receive an electrical component mounted thereto. In some embodiments, the at least one base 1457 includes a plurality of the bases 1457. In some embodiments, the interior portion 1455 includes an aperture 1459 that extends through a bottom portion of the housing 1453. In some embodiments, a cover portion 1461 extends outwardly from a lower wall 1463 of the housing 1453. In some embodiments, the cover portion 1461 includes flanged walls 1465. In some embodiments, the flanged walls 1465 are angled. In some embodiments, the cover portion includes tabs 1467 extending outwardly from the free end thereof.

In some embodiments, the transition box 1432 is installed on the first flashing base 1428 by fasteners. In some embodiments, the fasteners are screws that engage corresponding ones of the screw tabs 1451 of the first flashing base 1428. In some embodiments, the transition box 1432 is installed on the first flashing base 1428 by an adhesive. In some embodiments, the transition box 1432 is installed on the first flashing base 1428 by snap tabs. In some embodiments, the cover portion 1461 is sized and shaped to cover at least a portion of the sidewall 1435 and at least a portion of the aperture 1433 of the first flashing base 1428. In some embodiments, the flanged walls 1465 of the cover portion 1461 are juxtaposed with the flanged portions 1437 of the first flashing base 1428. In some embodiments, the tabs 1467 of the cover portion 1461 engage the cover 1304 of the wire cover bracket 1300. In some embodiments, the cover portion 1461 slidably engages the cover 1304 of the wire cover bracket 1300, such that a lower end of the cover portion 1461 is juxtaposed with an upper end of the cover 1304. In some embodiments, the cover portion 1461 of the transition box 1432 covers the first junction box 1238 of the jumper module 1210.

In some embodiments, the housing 1453 of the transition box 1432 is sized and shaped to cover at least another portion of the sidewall 1435 and at least a portion of the aperture 1433 of the first flashing base 1428. In some embodiments, at least a portion of the aperture 1459 of the transition box 1432 is substantially aligned with the aperture 1433 of the first flashing base 1428. In some embodiments, the aperture 1459 and the aperture 1433 substantially align with an aperture or penetration within the roof deck 1402. In some embodiments, the transition box 1432 covers the aperture or penetration in the roof deck 1402 and is used as part of a pathway to run electrical wiring therethrough. In some embodiments, a passthrough 1460 is located within the aperture 1459 and the aperture 1433. In some embodiments, the passthrough 1460 is inserted within the aperture or penetration of the roof deck 1402. In some embodiments, the passthrough 1460 is configured to receive an electrical wire or cable to facilitate its insertion through the roof deck aperture an into the associated structure.

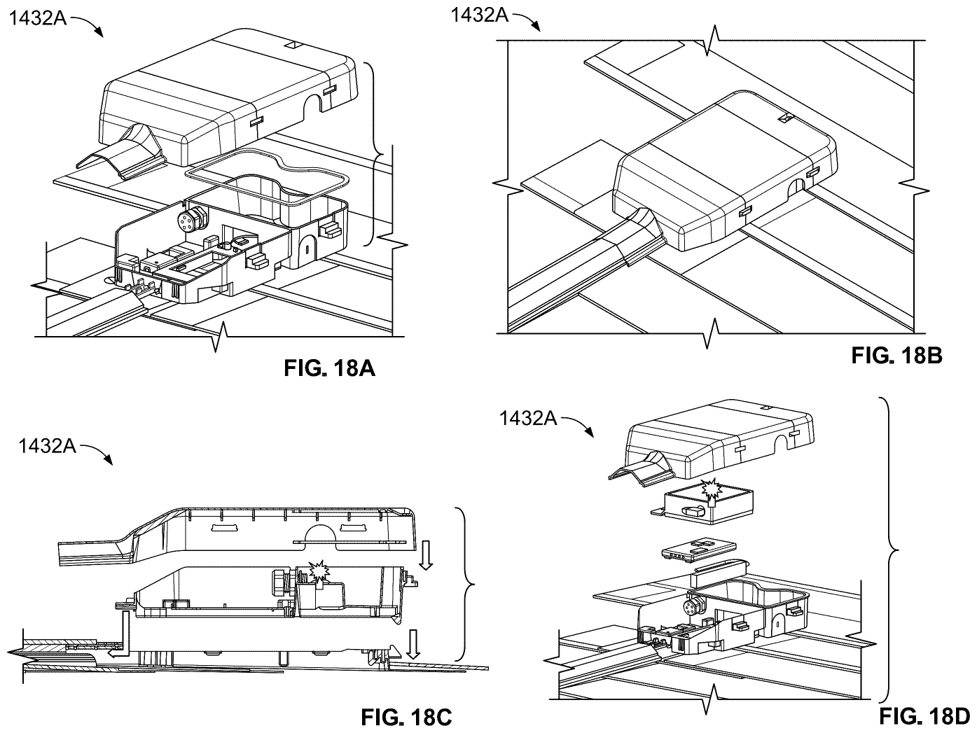

Referring to FIG. 17, in some embodiments, the transition box 1432 includes power electronics for the photovoltaic system 1400. In some embodiments, the transition box 1432 includes a rapid shutdown device (RSD). In some embodiments, the transition box 1432 includes a middle circuit interrupter (MCI) 1469. In some embodiments, the transition box includes a splice box 1471. In some embodiments, the transition box 1432 houses electrical wiring for the photovoltaic system 1400. In some embodiments, the electrical wiring includes THHN electrical wiring. In some embodiments, the THHN electrical wire is electrically connected to an inverter. In some embodiments, the rapid shutdown device (RSD) is located within 1 foot of the subarray S1. In some embodiments, the inverter drives the output voltage of the subarrays S1, S2 to a point where the inverter can extract the most power (Vmp). In some embodiments, the inverter drives the output voltage of the subarrays S1, S2 of 80% to 85% of the maximum voltage or open circuit voltage (Voc) of the photovoltaic system 1400. In some embodiments, Voc is greater than Vmp. In some embodiments, the inverter is configured to be shut down by a user by turning off a DC switch at the inverter. In some embodiments, the inverter is configured to be shut down by a user by turning off an AC breaker. In some embodiments, when the inverter is shut down, home-run cables between the subarrays S1, S2 and the inverter are de-energized. In some embodiments, the home-run cables between the subarrays S1, S2 and the inverter are de-energized to less than 30 volts in less than 30 seconds. In some embodiments, the photovoltaic modules 1110a, 1110b are in their open circuit voltage condition (Voc) with no current flowing.

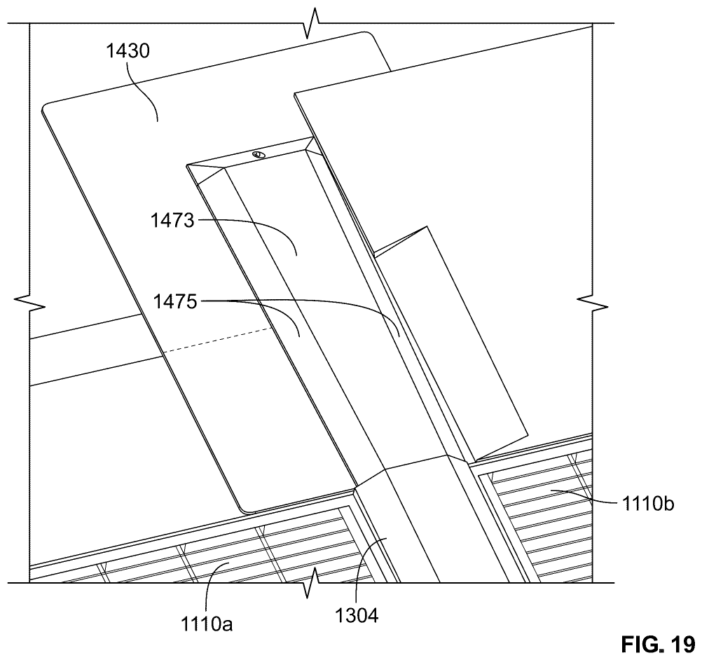

Referring to FIG. 18, in some embodiments, the transition box 1432 includes a cover 1434. In some embodiments, the cover 1434 is removably attached to the housing 1453. In some embodiments, the cover 1434 includes an interior surface. In some embodiments, the interior surface includes an interior wall structure that is configured to provide structural integrity and strength to the cover 1434. In some embodiments, the interior wall structure is configured to maintain its structural integrity due to hail impacts. In some embodiments, the interior wall structure is a honeycomb structure. In some embodiments, a sidewall 1470 of the transition box 1432 is configured to have an aperture formed therein, either by drilling or cutting. In some embodiments, the aperture is sized and shaped to receive a conduit connected to the splice box 1471. In some embodiments, the conduit is configured to house and run electrical wiring across the roof.

FIGS. 18A through 18D show other embodiments of a transition box 1432A.

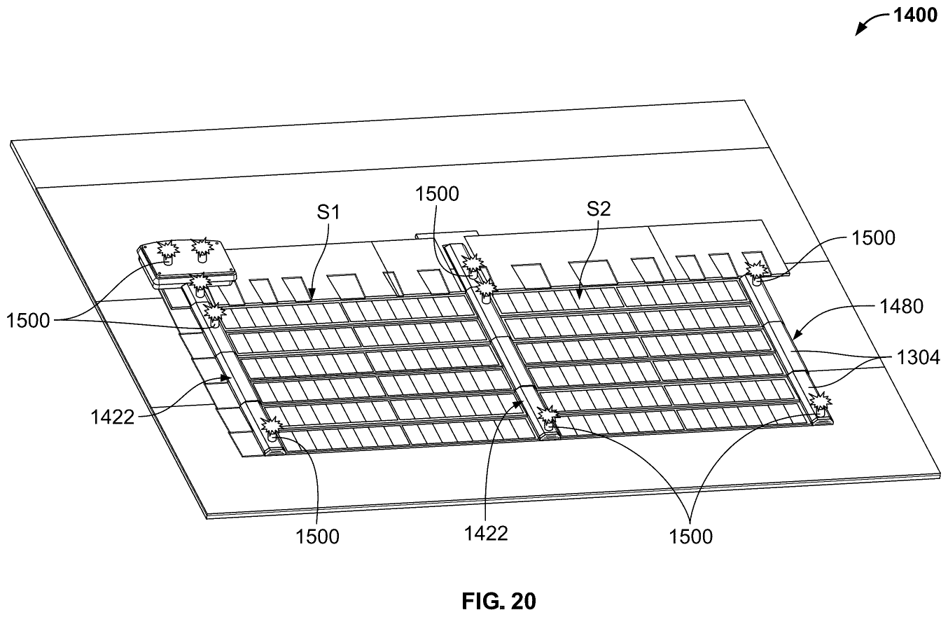

Referring to FIG. 19, in some embodiments, the second flashing base 1430 includes a cover 1473. In some embodiments, the cover 1473 is sized and shaped to cover the aperture 1433 of the second flashing base 1430. In some embodiments, flanged walls 1475 of the cover 1473 are juxtaposed with the flanged portions 1437 of the second flashing base 1430. In some embodiments, the cover portion 1461 slidably engages the cover 1304 of the wire cover bracket 1300, such that a lower end of the cover 1473 is juxtaposed with an upper end of the cover 1304. In some embodiments, the cover 1473 covers the second junction box 1240 of the jumper module 1210.

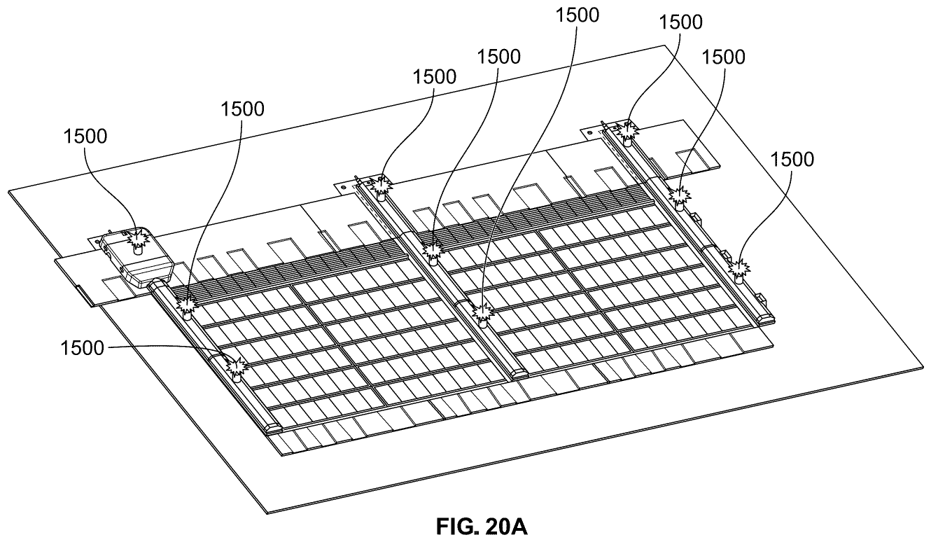

Referring to FIG. 20, in some embodiments, the photovoltaic system 1400 is installed on the roof deck 1402. In some embodiments, an additional, non-active (i.e., “dummy”) wireway 1480 and associated cover 1304, similar to the at least one wireway 1422 and the associated covers 1304, may be installed on the end of the second subarray S2 for symmetry and aesthetics. In some embodiments, the non-active wireway 1480 is installed over the second side laps 1117 of the photovoltaic modules 1110b. In some embodiments, the non-active wireway 1480 does not include any electrical components or electrical wiring. In some embodiments, the non-active wireway 1480 includes electrical components and/or electrical wiring. In some embodiments, the non-active wireway 1480 is optional and need not be included. In some embodiments, roofing shingles overlay the second side laps 1117 of the photovoltaic modules 1110b of the second subarray S2. In some embodiments, it should be understood that the non-active wireway 1480 or roofing shingles may overlay the second side laps 1117 of the photovoltaic modules 1110a of the first subarray S1 in the absence of the second subarray S2.

Referring to FIGS. 17 and 20, in some embodiments, at least one of the electronic component in the transition box 1432 includes at least one of the indicator 1500. In some embodiments, the rapid shutdown device (RSD) include at least one of the indicator 1500. In some embodiments, the middle circuit interrupter (MCI) 1469 includes at least one of the indicator 1500. In some embodiments, the splice box 1471 includes at least one of the indicator 1500. In some embodiments, the cover 1434 of the transition box 1432 includes a transparent section. In some embodiments, the transparent section of the cover 1434 is configured to enable visible perception of the at least one indicator 1500 when it is active (e.g., illuminated). In some embodiments, the indicator 1500 is not illuminated during normal operation of the photovoltaic system 1400. In some embodiments, the indicator 1500 is configured to turn on and illuminate when the rapid shutdown device is triggered. In some embodiments, the indicator 1500 is configured to turn on and illuminate when the inverter is shut down. In some embodiments, the indicator 1500 is configured to turn on and illuminate when the electrical voltage of the photovoltaic system 1400 is less than or equal to the predetermined voltage level. In some embodiments, the predetermined voltage level is 0.1 volt to 30 volts. In some embodiments, the indicator 1500 is configured to turn on and illuminate when a loss of a power line communication (PLC) signal to the rapid shutdown device is detected.

In some embodiments, the indicator 1500 is configured to show different status colors. In some embodiments, the indicator 1500 is configured to show different status colors, each of which depend on a measurable condition of either or both of the subarrays S1, S2. In some embodiments, the indicator 1500 is configured to show a first color when a voltage of the subarray S1 is a first value above a predetermined voltage level. In some embodiments, the first color is green. In some embodiments, the indicator 1500 is configured to show a second color when a voltage of the subarray S1 is above below a predetermined voltage level by at least a second value. In some embodiments, the second color is yellow. In some embodiments, the indicator 1500 is configured to show a third color when a voltage of the subarray S1 is above below a predetermined voltage level by at least a third value. In some embodiments, the third color is red. In some embodiments, a status of the indicator 1500 is communicated to a user. In some embodiments, the third color is red.

In some embodiments, a status of the indicator 1500 is communicated electronically a user. In some embodiments, the third color is red. In some embodiments, the indicator 1500 is configured to pulse out a code. In some embodiments, the code is representative of the status of the voltage of the subarray S1. In some embodiments, the indicator 1500 is configured to pulse out a first code when a voltage of the subarray S1 is above a predetermined voltage level by a first value. In some embodiments, the indicator 1500 is configured to pulse out a second code when a voltage of the subarray S1 is above below a predetermined voltage level by at least a second value. In some embodiments, the indicator 1500 is configured to pulse out a third code when a voltage of the subarray S1 is above below a predetermined voltage level by at least a third value. In some embodiments, a status of the indicator 1500 is communicated to an electronic device of a user. In some embodiments, the electronic device is a computer device. In some embodiments, the electronic device is a personal computer, laptop computer, smartphone, computer tablet, or a smart watch. It is understood that the foregoing function of the indicator 1500 may be applied to the subarray S2. In some embodiments, the predetermined voltage level is programmable by a user. In some embodiments, the predetermined voltage level is field programmable by a user.

In some embodiments, the indicators 1500 remains in an inactive (e.g., off or dark) states when the inverter is operating within normal parameters. In some embodiments, when the array S1, S2 are not activated and not powered during normal operation (e.g., at night), the indicators 1500 remain in their inactive state.

In some embodiments, at least one of the indicators 1500 is activated when the at least one bypass diode 1123 fails. In some embodiments, the failure of the at least one bypass diode 1123 may be caused by a long period at high current and high temperature when they are actively bypassing shaded cells 1112, or due to their peak inverse voltage rating being exceeded such as when a nearby lightning strike occurs. In some embodiments, the failed at least one bypass diode 1123 results in a closed circuit with the connected solar cells 1112. In some embodiments, the indicator 1500 is configured to be electrically connected to the closed circuit and activate.

FIG. 20A illustrates another embodiment of a photovoltaic system including a plurality of the indicators 1500.

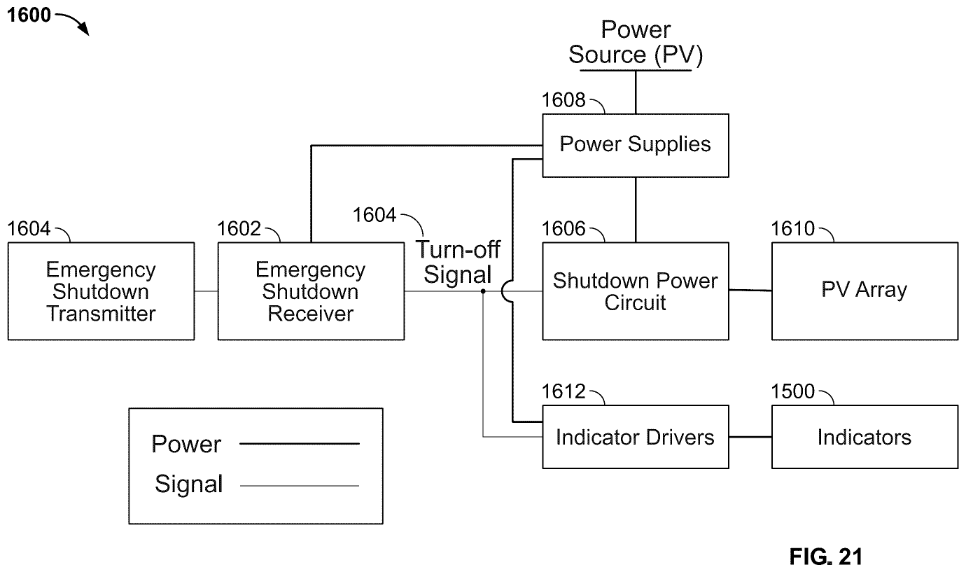

FIG. 21 illustrates a block-diagram of some embodiments of the indicators 1500 integrated with a rapid shutdown system 1600. In some embodiments, the rapid shutdown system 1600 includes an emergency shutdown receiver 1602, an emergency shutdown transmitter 1604 electrically connected to the emergency shutdown receiver 1602, a shutdown power circuit 1606 electrically connected to the emergency shutdown receiver 1602, and a power supply 1608, all of which are electrically connected to a photovoltaic array (PV array) 1610 comprising a plurality of photovoltaic modules. In some embodiments, the rapid shutdown system 1600 includes an indicator circuit that comprises at least one indicator 1500 and indicator drivers 1612. In some embodiments, the indicator circuit is electrically connected to the emergency shutdown receiver 1602 and the shutdown power circuit 1606. In some embodiments, the indicator circuit is powered by the power supply 1608. In some embodiments, the power supply 1608 is a photovoltaic module. In some embodiment, the power supply 1608 is an independent source of power. In some embodiments, the power supply 1608 is an energy storage device. In some embodiments, the power supply 1608 is at least one battery. In some embodiments, the emergency shutdown receiver 1602 detects a shutdown command or senses a lack of a signal indicating normal operation. In some embodiments, the signal is a power line communication signal. In some embodiments, a shutdown code or word is transmitted by the emergency shutdown transmitter 1604 to the emergency shutdown receiver 1602. In some embodiments, the transmission of the shutdown code or word is via wired communication. In some embodiments, the transmission of the shutdown code or word is via wireless communication. In some embodiments, a user initiates a turn off state. In some embodiments, the indicator circuit utilizes the turnoff signal and activates the indicators 1500.

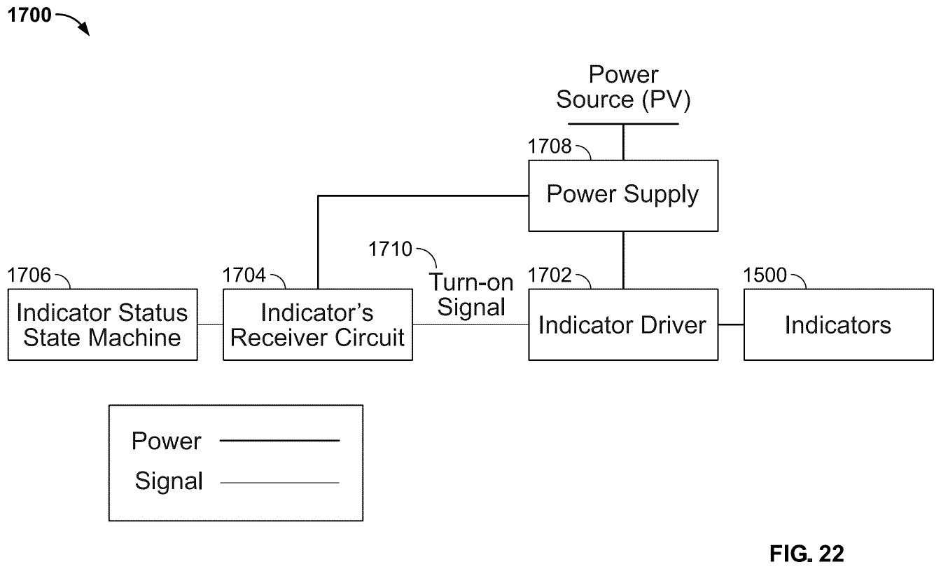

FIG. 22 illustrates a block-diagram of some embodiments of the indicators 1500 as part of a stand-alone system 1700 independent of the rapid shutdown device. In some embodiments, the system 1700 includes an indicator driver 1702, an indicator receiver circuit 1704 electrically connected to the indicator driver 1702, an indicator status state machine 1706 electrically connected to the indicator receiver circuit 1704, at least one of the indicators 1500 electrically connected to the indicator driver, and a power supply 1708. In some embodiments, the indicator receiver circuit 1704 detects a status state signal of the indicator status state machine 1706. In some embodiments, a turn-on signal 1710 is generated and the indicator driver 1702 turns on the indicators 1500. In some embodiments, the system 1700 includes switch to turn on and off the indicators 1500. In some embodiments, the switch is a wired switch. In some embodiments, the switch is a wireless switch.

Referring to FIGS. 11 and 20, in some embodiments, power electronic components (e.g., a rapid shutdown device (RSD), middle circuit interrupter (MCI), junction box) are located at a top portion of the wireway 1422. In some embodiments, the power electronic components are located at bottom portion of the wireway 1422. In some embodiments, at least one of the power electronic components includes at least one of the indicators 1500. In some embodiments, each of a plurality of the power electronic components includes at least one of the indicators 1500. In some embodiments, each of the covers 1304 of the corresponding wire cover brackets 1300 includes a transparent section. In some embodiments, the transparent section of the cover 1304 is configured to enable visible perception of the at least one indicator 1500 when it is active (e.g., illuminated).

In some embodiments, the junction box 1238 of the jumper module 1210 includes a voltage monitoring device and at least one of the indicators 1500. In some embodiments, the cover portion 1461 of the first flashing base 1428 includes a transparent section. In some embodiments, the transparent section of the cover portion 1461 is configured to enable visible perception of the at least one indicator 1500 when it is active (e.g., illuminated). In some embodiments, the junction box 1240 of the jumper module 1210 includes a voltage monitoring device and at least one of the indicators 1500. In some embodiments, the cover 1473 of the second flashing base 1430 includes a transparent section. In some embodiments, the transparent section of the cover 1473 is configured to enable visible perception of the at least one indicator 1500 when it is active (e.g., illuminated). In some embodiments, the voltage monitoring device is an in-laminate printed circuit board (PCB) or flex circuit. In some embodiments, the flex circuit is located on an exposed surface of the jumper module 1210. In some embodiments, the flex circuit is laminated within the active portion 1212 of the jumper module 1210. In some embodiments, the flex circuit is laminated within the frontsheet 1246 of the jumper module 1210.

In some embodiments, each of the photovoltaic modules 1110a, 1110b includes a voltage monitoring device and at least one of the indicators 1500. In some embodiments, the voltage monitoring device is an in-laminate printed circuit board (PCB) or flex circuit. In some embodiments, the flex circuit is located on an exposed surface of each of the photovoltaic modules 1110a, 1110b. In some embodiments, the flex circuit is laminated within the active area 1109 of the photovoltaic module 1110. In some embodiments, the flex circuit is laminated within the frontsheet 1116 of the photovoltaic module 1110. In some embodiments, the flex circuit is laminated within the first side lap 1115 of the photovoltaic module 1110.

In some embodiments, a method comprises the steps of:
monitoring an electrical voltage of the photovoltaic system 1400 wherein the photovoltaic system 1400 includes a plurality of the photovoltaic modules 1110 installed on a roof deck, wherein the photovoltaic modules 1110 are arranged in an array on the roof deck, wherein each of the photovoltaic modules 1110 includes a first end and a second end opposite the first end, at least one solar cell 1112, and at least one electrical component, a rapid shutdown device, wherein the rapid shutdown device is electrically connected to the at least one electrical component, and at least one visible indicator 1500, wherein the at least one visible indicator 1500 is electrically connected to the plurality of photovoltaic modules 1110;
activating the rapid shutdown device to reduce the electrical voltage of the photovoltaic system 1400 to a predetermined voltage level; and
activating the at least one visible indicator 1500 when the electrical voltage of the photovoltaic system 1400 is less than or equal to the predetermined voltage level.

It should be understood that the embodiments described herein are merely exemplary and that a person skilled in the art may make many variations and modifications without departing from the spirit and scope of the invention. All such variations and modifications are intended to be included within the scope of the invention.

1-20. (canceled)

21. A system, comprising:
a plurality of photovoltaic modules installed on a roof deck,
wherein each of the plurality of photovoltaic modules includes
a first side lap portion,
a plurality of solar cells,
a power electronics unit on the first side lap portion, wherein
the power electronics unit is electrically connected to the plurality of solar cells,
wherein the power electronics unit includes at least one first visible indicator,
wherein the at least one first visible indicator is electrically connected to the plurality of photovoltaic modules, and
wherein the at least one first visible indicator is activated when an electrical voltage of the system is less than or equal to a predetermined voltage level.

22. The system of claim 21, wherein the power electronics unit includes a rapid shutdown device, wherein the rapid shutdown device is configured to reduce the electrical voltage of the system to the predetermined voltage level.

23. The system of claim 21, wherein the power electronics unit includes an optimizer, a bypass diode, system monitoring electronic components, a rapid shutdown device, or electronic communication components.

24. The system of claim 21, wherein each of the plurality of photovoltaic modules includes a wire cover bracket located on the first side lap portion and configured to receive the power electronics unit, wherein the wire cover brackets of the plurality of photovoltaic modules is configured to form a wireway.

25. The system of claim 21, wherein each of the at least one first visible indicator includes a light source.

26. The system of claim 25, wherein the light source of the at least one first visible indicator is a first light emitting diode (LED).

27. The system of claim 25, wherein the at least one first visible indicator includes a plurality of first visible indicators.

28. The system of claim 24, further comprising at least one cover removably attached to at least one of the wire cover brackets, wherein the at least one cover is configured to enable visible perception of the at least one first visible indicator when the at least one first visible indicator is active.

29. The system of claim 21, further comprising at least one voltage monitoring device, wherein the at least one voltage monitoring device is configured to measure the electrical voltage of the system.

30. The system of claim 29, wherein the plurality of photovoltaic modules is arranged in an array, wherein the array includes a first subarray and a second subarray, wherein the system further comprises a jumper module, wherein the jumper module electrically connects the first subarray and the second subarray.

31. The system of claim 30, wherein the jumper module includes a first junction box, and wherein the first junction box includes the at least one voltage monitoring device.

32. The system of claim 30, wherein the jumper module includes a plurality of layers, wherein the plurality of layers is laminated, and wherein the at least one voltage monitoring device is laminated within the plurality of layers of the jumper module.

33. The system of claim 31, wherein the at least one voltage monitoring device is a printed circuit board or flex circuit.

34. The system of claim 32, wherein at least one second visible indicator is located on the jumper module.

35. The system of claim 29, wherein the at least one voltage monitoring device includes a plurality of voltage monitoring devices, and wherein each of the plurality of voltage monitoring devices is located on a corresponding one of the plurality of photovoltaic modules.

36. The system of claim 21, wherein the predetermined voltage level is 0.1 volt to 30 volts.

37. The system of claim 21, wherein the at least one first visible indicator displays a first color when the electrical voltage has a first value, and wherein the at least one first visible indicator displays a second color different from the first color when the electrical voltage has a second value, wherein the second value is different from the first value.

38. The system of claim 21, wherein the at least one first visible indicator displays a first flashing code when the electrical voltage has a first value, and wherein the at least one first visible indicator displays a second flashing code different from the first flashing code when the electrical voltage has a second value, wherein the second value is different from the first value.

39. The system of claim 22, wherein the rapid shutdown device includes
a shutdown receiver,
a shutdown transmitter electrically connected to the shutdown receiver,
a shutdown power circuit electrically connected to the shutdown receiver, and
an indicator circuit electrically connected to the shutdown receiver and the shutdown power circuit,
wherein the shutdown receiver, the shutdown transmitter and the shutdown power circuit are electrically connected to the photovoltaic modules,
wherein the indicator circuit is electrically connected to the shutdown receiver and the shutdown power circuit,
wherein the shutdown receiver is configured to detect a shutdown signal transmitted by the shutdown transmitter when the electrical voltage of the system is less than or equal to the predetermined voltage level, and
wherein the indicator circuit is configured to receive the shutdown signal and activate the at least one first visible indicator in response to the receipt of the shutdown signal.

40. A system, comprising:
a plurality of photovoltaic modules installed on a roof deck,
wherein the plurality of photovoltaic modules includes
at least a first photovoltaic module and a second photovoltaic module,
wherein the first photovoltaic module is vertically adjacent to the second photovoltaic module,
wherein each of the plurality of photovoltaic modules includes:
a first end and a second end opposite the first end,
a headlap portion extending between the first end and the second end,
a first side lap portion located at the first end,
a plurality of solar cells,
a power electronics unit on the first side lap portion, wherein the power electronics unit is electrically connected to the plurality of solar cells, and
wherein the power electronics unit includes a rapid shutdown device and at least one first visible indicator,
wherein the rapid shutdown device is configured to reduce an electrical voltage of the system to a predetermined voltage level,
wherein the second photovoltaic module overlays at least a part of the headlap portion of the first photovoltaic module, and
wherein the at least one first visible indicator in at least one of the plurality of photovoltaic modules is activated when the electrical voltage of the system is less than or equal to the predetermined voltage level.
